(19) United States
(12) Patent Application Publication
(10) Pub. No.: US 2017/0161292 A1
(43) Pub. Date: Jun. 8, 2017

(54) Digital Content Item Collection Management Boxes (CCMBoxes) - Virtual digital content item collection, characterization, filtering, sorting, management and presentation systems, methods, devices and associated processing logic

(71) Applicants: Ido Sher Sever, Sde-Warburg (IL); Carmit Hirsch Ram, Ramat-Hasharon (IL); Idan Elgar, Ein-Vered (IL)

(72) Inventors: Ido Sher Sever, Sde-Warburg (IL); Carmit Hirsch Ram, Ramat-Hasharon (IL); Idan Elgar, Ein-Vered (IL)

(21) Appl. No.: 15/354,785

(22) Filed: Nov. 17, 2016

Related U.S. Application Data
(60) Provisional application No. 62/256,140, filed on Nov. 17, 2015.

(51) Int. Cl. G06F 17/30; G06F 13/14; G06F 9/00; G06F 3/048

(52) U.S. Cl. CPC G06F 17/30126; G06F 17/30554; G06F 17/30876; G06F 3/048; G06F 13/14; G06F 9/00

(57) ABSTRACT

Disclosed are systems, methods, devices and associated processing logic for generating and managing virtual digital content item collections. A first electronic interface is configured to interface with a publisher user and receive a set of parameters defining rules of inclusion and context parameters of a new digital item collection. A second electronic interface is configured to interface with one or more digital content suppliers, to communicate to them the rules of inclusion and context parameters of the new digital item collection and to receive candidate digital content items for the digital item collection. A Digital Content Item Collection Management Box (CCMBox) computerized server is configured to: select digital content items to be added to the new digital item collection from the candidates and to store the selected digital content items as members of the new digital item collection.

### RELATED APPLICATIONS

The present invention claims priority form U.S. Provisional Patent Application No. 62/256,140, filed Nov. 17, 2015, which is hereby incorporated by reference in its entirety.

### FIELD OF THE INVENTION

The present invention is a contextual digital content-collection and content-sharing platform, which allows users to share content, such as digital photos, directly into live media publications. The invention generally relates to the fields of digital publication and crowdsourced user generated content delivery, and more particularly, to digital Content Item Collection Management Boxes (CCMBoxes)—Virtual digital content item collection, characterization, filtering, sorting, management and presentation systems, methods, devices and associated processing logic.

### BACKGROUND

Publishers and Bloggers of digital publications are increasingly trying to provide an engaging experience and create a connection with their publications consumers. As an example, Buzz feed, (www.buzzfeed.com) which is a social news and entertainment company, has been growing rapidly to more than 200 million users by providing an experience where users typically not only consume the digital publication but also engage (by answering a quiz, selecting a reaction to the story out of a few options etc.) and share the posts.

In addition, Publishers and Bloggers of digital publications are increasingly trying to engage and receive from their publication consumers UGC (user generated content) which could typically contribute and provide authenticity to the story being told in the publication. As an example, The New York Times, in their innovation report for 2014, have proposed “connection” with their consumers as one of the three suggested areas to explore innovation, saying that “Our readers are perhaps our greatest untapped resource. Deepening our connection with them both online and offline is critical in a world where content so often reaches its broadest audience on the back of other readers. And many readers have come to expect a two-way relationship with us, so they can engage with our journalism and our journalists. This means the newsroom as a whole must take the reins in pursing user-generated content, events and other forms of engagement in a way that reflects our standards and values.” (The New York Times: Innovation, Mar. 24, 2014, page 49).

The amounts and variety of crowdsourced user generated visual content used by blogs and other digital media publishers, as part of the entire content delivered, has been rapidly increasing in the last several years.

Publishers trying to include visual user generated content in their publications, face several challenges such as curation, authentication, quality and access to content.

People who wish to share visual content would typically do so using one of today's major social networks (such as Facebook, Instagram, Twitter, WhatsApp or Snapchat). Some of such content is shared into the social networks private feeds, or into public feeds which have different licensing or accessing constraints, and therefore hard for publishers/bloggers to use.

There remains a need, in the fields of digital publication and crowdsourced user generated content delivery, for solutions that may facilitate the combination of crowdsourced user generated content into associated digital publications, provide means for collecting, characterizing, filtering, sorting, managing, presenting, curating and/or elsewise treating the crowdsourced content. The provided solutions may enable users to characterize and prioritize the combination of the crowdsourced digital content into the associated digital publications. These solutions may allow for both Publishers/Bloggers and content contributors to be part of the same social graph, also allowing them to easily communicate with each other and reduce the friction involved in the process of obtaining, curating and authenticating content.

### SUMMARY OF THE INVENTION

According to some embodiments, there may be provided systems, methods, devices and associated processing logic for combining user sourced content into digital publications. A system in accordance with some embodiments of the present invention, may form a contextual content/photo-sharing platform which enables users to share content, such as but not limited to visual content, directly into digital publications (e.g. blog post, post, article, news update, column). The invention may also enable publishers, to create and add a user generated content-item/photo collection/‘gallery’ (hereinafter “CCMBox”) into digital publications, to edit and manage them and/or to invite the crowd to provide their take of the story and contribute content (e.g. visual content) to the collection/gallery.

The present invention includes Digital Content Item Collection Management Boxes (CCMBoxes), which are Virtual digital content item collection, characterization, filtering, sorting, management and presentation systems, methods, devices and associated processing logic.

The present invention also includes systems, devices, methods and associated processing logic for automatically characterizing and/or classifying/tagging digital content items based on a context found correlated to the items (e.g. because the items were approved for a CCMBox characterized by the given context).

According to some embodiments, CCMBoxes may be characterized by a context. A context of a CCMBox may be defined by a set of one or more setting/environmental parameters and/or by a location/environment the CCMBox is intended to populate.

According to some embodiments, a CCMBox may comprise one or more electronic interfaces for communicating over a data network (e.g. the Internet) with digital content suppliers. 1 he CCMBox may include electronic interfaces that may be used for receiving from the digital content suppliers, candidate digital content for the CCMBox. According to some embodiments, digital content suppliers may be selected/filtered based on any relevant criteria.

According to some embodiments, a CCMBox may include interfaces and/or virtual frameworks for facilitating communication between digital content suppliers and administrators of CCMBoxes (e.g. the publisher of the article). A CCMBox may be further designed to facilitate communication in direct association with a digital item or a set of digital items.

According to some embodiments, digital content suppliers may communicate with publishers of articles/blogs/publications including CCMBox(es) (e.g. publishers which selected them as content suppliers for their publication's CCMBox(es)) possibly within the context of a specific CCMBox. Digital content suppliers may upload media content items to one or more CCMBox(es), either as candidate items or for direct presentation on CCMBoxes for which the media content suppliers have already been selected.

According to some embodiments, a CCMBox may comprise one or more electronic interfaces for receiving selection or filtering parameters of media content suppliers, for providing digital content to the CCMBox over a data network.

According to some embodiments, a CCMBox may comprise one or more processors for automatic digital content characterization based on natural language processing of context and feedback and the automated monitoring of user computer action/reaction relating to the digital content.

Digital content characterization may include the rating and tagging of: digital content items, digital content items collections (CCMBoxes) and the different users interfacing with them. Based on the ratings and tags, matchings between: digital content items, CCMBox(es) and system users, may be made. And various digital content associated suggestions/recommendations may be generated.

According to some embodiments, a CCMBox may comprise one or more electronic interfaces for automatically managing and facilitating user management of the CCMBox and the media content contained therein. Electric management interfaces may include, but are not limited to: a standalone mobile application, a web-browser based application, and/or a built-in plugin or add-on for publishing/website-construction platform(s) (e.g. WordPress, Wix). The electronic interfaces may receive CCMBox management instructions: communicated by users such as CCMBox publishers or curators, and/or generated/triggered by an automatic CCMBox management logic of the CCMBox.

According to some embodiments, a CCMBox may comprise one or more image, video, or audio processors for processing digital content within the CCMBox prior to presentation of the digital content.

According to some embodiments, digital content may be processed to improve its quality. Digital content quality related processing may include: application of filters, tuning of contrast, tuning of colors and shades, tuning of brightness of images or video digital content items and/or processing/modifying/tuning any other digital image properties.

According to some embodiments, digital content may be processed to change/modify its content and/or size. Digital content related processing of the content may include: identification and marking of elements (e.g. faces) within images or videos, deletion or blurring of elements within images or videos, marking or highlighting of elements within images or videos and/or the addition or augmentation of elements (e.g. animated images/icons, information layers) onto images or videos.

According to some embodiments, digital content may be processed to include a graphic code (e.g. QR code), an icon and/or a watermark. The graphic-code/icon/watermark may be automatically embedded into digital content items in the CCMBox, for example, at their CCMBox presentation approval or prior to their presentation.

According to some embodiments, a CCMBox may comprise an electronic interface for presenting a selection of digital content items from the collection within the CCMBox based on one or more presentation rules and/or schemes.

According to some embodiments, a CCMBox may present to a consumer/viewer, or relay for presentation on a consumer/viewer communication device, the selection of digital content items. The electronic interface for presenting a selection of digital content items may present the content items as a customized presentation.

According to some embodiments, the CCMBox may receive through the electronic (presentation) interface control commands from the Curator of the CCMBox and\or from the Publisher of the publication including the CCMBox.

Control commands may: instruct which digital content items to present and in which order; provide presentation customization parameters, such as display colors, dimensions and layout for visual digital content items presented, provide presentation theme/type selection (e.g. present a single content item at a time, present a collage/album of x content items, present as a slideshow or gallery, present a subset of specific content items).

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings:

FIG. 1 is a block diagram of the operational environment of an exemplary CCMBoxes system for virtual digital content item collection, characterization, filtering, sorting, management and presentation, in accordance with some embodiments of the present invention; in the figure there are shown the main entities, users and/or devices interfaced by the CCMBoxes system, including relevant modules and components thereof;

FIG. 2A shows an exemplary operation flow of interfacing with a publisher/editor device, in accordance with some embodiments of the present invention;

FIG. 2B shows an exemplary operation flow of interfacing with a consumer/viewer device, in accordance with some embodiments of the present invention;

FIG. 2C shows an exemplary operation flow of interfacing with a supplier/shooter device, in accordance with some embodiments of the present invention;

FIG. 2D shows an exemplary operation flow of interfacing with a curator/console device, in accordance with some embodiments of the present invention;

FIG. 3A shows a CCMBoxes embedded into a text publication, in accordance with some embodiments of the present invention;

FIG. 3B shows multiple CCMBoxes embedded into a text publication, in accordance with some embodiments of the present invention;

FIG. 3C shows CCMBoxes embedded into a webpage, in accordance with some embodiments of the present invention;

FIG. 3D shows multiple CCMBoxes embedded into a website, in accordance with some embodiments of the present invention;

FIG. 3E shows multiple CCMBoxes embedded into another CCMBox that is embedded in a text publication, in accordance with some embodiments of the present invention;

FIG. 4A shows an exemplary user interface of a publishing platform onto which a Publisher/Editor-Module has been installed, in accordance with some embodiments of the present invention;

FIG. 4B shows an exemplary user interface of a Consumer/Viewer, viewing a digital publication including an Editor-User added CCMBox, in accordance with some embodiments of the present invention;

FIG. 4C shows an exemplary user interface of a Supplier/Shooter-Module-Lobby, in accordance with some embodiments of the present invention;

FIG. 4D shows an exemplary user interface of a CCMBox, in accordance with some embodiments of the present invention;

FIG. 4E shows a first view of an exemplary user interface of a Console-Module, in accordance with some embodiments of the present invention;

FIG. 4F shows a second view of an exemplary user interface of a Console-Module, in accordance with some embodiments of the present invention;

FIG. 4G shows a third view of an exemplary user interface of a Console-Module, in accordance with some embodiments of the present invention;

FIG. 4H shows a fourth view of an exemplary user interface of a Console-Module, in accordance with some embodiments of the present invention;

FIG. 5 is a block diagram of an exemplary CCMBoxes system for virtual digital content item collection, characterization, filtering, sorting, management and presentation, in accordance with some embodiments of the present invention; in the figure there are shown the main components, processors, interfaces, and databases utilized by the CCMBoxes system and the interconnections and relations of the components, processors, interfaces, and databases;

FIG. 6 is a flowchart diagram of the main operation steps and process, executed by an exemplary CCMBoxes system for virtual digital content item collection, characterization, filtering, sorting, management and presentation, in accordance with some embodiments of the present invention;

FIG. 7 is a block diagram of a Digital Content Characterization Processor of an exemplary CCMBoxes system, in accordance with some embodiments of the present invention; in the figure, there are shown the different processing logics of the Digital Content Characterization Processor, the information flow and exchange between the processing logics and their main inputs and outputs;

FIG. 8A shows a flowchart diagram describing the main processes and operation steps of an exemplary process for Features Based Content Item Rating, in accordance with some embodiments of the present invention;

FIG. 8B shows a flowchart diagram describing the main processes and operation steps of an exemplary process for Text and Language Based Content Item Tagging, in accordance with some embodiments of the present invention;

FIG. 8C shows a flowchart diagram describing the main processes and operation steps of an exemplary first process for Matching and Suggestion of Publication Content, in accordance with some embodiments of the present invention;

FIG. 8D shows a flowchart diagram describing the main processes and operation steps of an exemplary second process for Matching and Suggestion of Publication Content, in accordance with some embodiments of the present invention;

FIG. 8E shows a flowchart diagram describing the main processes and operation steps of an exemplary process for Matching and Suggestion of Content to/for CCMBox(es) and Publishers, in accordance with some embodiments of the present invention;

FIG. 8F shows a flowchart diagram describing the main processes and operation steps of an exemplary process for Suggestion of Requested/Aspired Content for CCMBox(es) to Content Suppliers/Contributors, in accordance with some embodiments of the present invention; and

FIG. 8G shows a flowchart diagram describing the main processes and operation steps of an exemplary process for Supplier/Contributor Content Item Portfolio Management, in accordance with some embodiments of the present invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Unless specifically stated otherwise, as apparent from the following discussions, it is appreciated that throughout the specification discussions utilizing terms such as “processing”, “computing”, “calculating”, “determining”, or the like, may refer to the action and/or processes of a computer, computing system, computerized mobile device, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In addition, throughout the specification discussions utilizing terms such as “storing”, “hosting”, “caching”, “saving”, or the like, may refer to the action and/or processes of ‘writing’ and ‘keeping’ digital information on a computer or computing system, or similar electronic computing device, and may be interchangeably used. The term “plurality” may be used throughout the specification to describe two or more components, devices, elements, parameters and the like.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device, for example a computerized device running a web-browser.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk-read only memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution. The memory elements may, for example, at least partially include memory/registration elements on the user device itself.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

Furthermore, throughout the specification, discussions utilizing the term ‘Publication’ or ‘Digital Publication’ may refer to any type of digital publication or digitally shared content, such as, but in no way limited to: blogs, posts, articles, news updates and bulletins, columns, any multi-user shared web/network environment such as a web-game or web-conference, and/or the like. In some cases, more specific terms such as ‘blogs’, ‘posts’, ‘articles’ or the like, may have been used, this however, is not to limit the scope of the associated teachings or features, all of which may apply to any form of digital publication and/or digitally shared content.

Moreover, the term ‘content’, and/or any other more specific content-describing terms such as ‘digital content’, ‘content items’, ‘media’, ‘media content’, ‘visual content’, ‘photo’, ‘image’ or the like, is not to limit the scope of the associated teachings or features, all of which may apply to any form of digital content known today, or to devised in the future, such as, but not limited to—visual, acoustic, smell based, taste based, sense based, and/or any combination thereof.

Throughout the specification, discussions may utilize the following terms:
Digital Publication—a digital, blog, post, article, news update, column, news bulletin, and/or the like;
Digital Publisher—the writer, editor and/or composer of a digital publication;
Digital Publishing Platform/Publishing Platform/Digital Publisher Platform—a software platform for the writing, editing, composing and/or publishing of a digital publication;
Publishing Platform Plugin/Code—a software module, or code lines, for adding features to a Digital Publishing Platform;
CCMBox—a user generated content/photo collection/‘gallery’;
Editor Module/Application—a set of editing associated features added to a publishing platform utilizing a Publishing Platform Plugin;
Editor User(s)/Editor(s)—users (e.g. Digital Publisher(s)) who add CCMBoxes to the Digital Publications they create and publish;
Supplier/Contributor/Shooter Module/Application—content acquisition, upload and integration associated features added to a computerized user device;
Supplier/Contributor/Shooter User(s)/Supplier(s)/Contributor(s)/Shooter(s)—users who contribute the content to the CCMBoxes;
Console/Curator/Administrator Module/Application—content curation, filtering, administration and approval associated features added to a user computerized device;
Console User(s)/Curator(s)—users who curate, filter and/or approve the content in the Photo-Boxes;
Consumer/Viewer/Consumer/Viewer User(s)—consumers (e.g. through a web-browser or 3^{rd} party application) of the published Digital Publication (e.g. post/article) who can see and engage with Photo-Boxes, and/or content thereof, in the posts/articles they access/read;
Shooter/Supplier/Contributor Module/Application Lobby/Shooter Lobby—CCMbox pool of the Shooter/Supplier/Contributor Module; and
Console/Curator Module/Application Lobby/Console Lobby—CCMBox pool of the Console/Curator Module.

The present invention includes Digital Content Item Collection Management Boxes (CCMBoxes), which are Virtual digital content item collection, characterization, filtering, sorting, management and presentation systems, methods, devices and associated processing logic.

The present invention also includes systems, devices, methods and associated processing logic for automatically characterizing and/or classifying/tagging digital content items based on a context found correlated to the items (e.g. because the items were approved for a CCMBox characterized by the given context).

According to some embodiments, CCMBoxes may be characterized by a context. A context of a CCMBox may be defined by a set of one or more setting/environmental parameters and/or by a location/environment the CCMBox is intended to populate.

According to some embodiments, a setting/environment of a CCMBox may be: (1) an article or publication in which the CCMBox is embedded, or otherwise functionally associated with; (2) a website or other virtual surrounding of the CCMBox; (3) the author or publisher of the article/publication in which the CCMBox is embedded and his former publications; (4) the media/web platform/environment (e.g. website) in which the article/publication is published; (5) the title or other description given to the CCMBox by the author/publisher; (6) the media items included in the CCMBox during initial generation; and/or (7) the positioning of the CCMBox(es) along the body of the article/publication.

According to some embodiments, a CCMBox may include physical settings relating to the presentation/imagery of the digital content items contained therein. Such physical settings may be pre-defined, by a publisher of textual content, by a person authorized/enabled by the publisher and/or automatically, such as by processing circuitry using a triggering or rule mechanism and/or a request or a query (e.g. a new article opens a new CCMBox, a publisher election triggers a new CCMBox, rule opens a CCMBox for blog article associated with a top Twitter trend). Context of a CCMBox may include any of the following characteristics and parameters:

Physical characteristics, parameters, and/or definitions of the CCMBox may include:
(1) Natural language text associated with the CCMBox (e.g. an article into which the CCMBox is integrated, a title of the CCMBox or of media content item the CCMBox includes);
(2) Graphic content characteristics preferences as context-wise defined by the publisher, for example an image lighting preference (i.e. exposure) for the CCMBox—(e.g. “dark photos of bridges”);
(3) Location/positioning of the CCMBox within the text (e.g. of the article, blog);
(4) Place, venue, location and/or area that is associated with the CCMBox (e.g. from a list/map/free text), may trigger requests for digital content items from/associated-with a specific location (e.g. content suppliers are requested to upload photos taken at that location);
(5) Date, time, or period, that is associated with the CCMBox, may trigger requests for digital content items acquired-at/associated-with the specified time/period;
(6) Viewing characteristics of the CCMBox, for example, is it visible to all or only to a selected set of users or user groups;
(7) Contributing characteristics of the CCMBox, for example, is it contributable by all and anyone can contribute media content to it or only to a selected set of users or user groups;
(8) Curating related characteristics of the CCMBox, for example, is and/or what type of curation is needed for media content items to be published within the CCMBox. Who is approved to curate content for publication within the CCMBox (e.g. a list of all users or groups that can curate) and/or what content is approved to curate (e.g. automated curation); a according to some embodiments, CCMBox may also be defined to immediately/automatically publish all media content supplied/uploaded without any curation process;
(9) A theme, sentiment, and/or any other semantic characteristic added by the publisher, and/or associated with, the CCMBox;
(10) Size or Volume of the CCMBox determining the amount of data/media storage the CCMBox is limited to;
(11) Expected size, and/or relative size, of the CCMBox;—
(12) Presentation time periods as context-wise defined by the publisher, for example a time of day association for the CCMBox (e.g. “people in the morning”);
(13) Media type (e.g. still image, video, sound, text) of content items allowed/requested for the CCMBox by the publisher; and/or
(14) Hierarchy and/or relations between and across CCMBoxes in one or more of the above parameters.

According to some embodiments, context of a CCMBox may further include, or be further defined by, design related characteristics, definitions and parameters that may visually represent one or more elements/parts of a CCMBox, its entirety and/or a set of two or more CCMBoxes. CCMBox Design characteristics/parameters and their definition is not limited to CCMBox web applications only and may be applied for CCMBoxes shown over TV screens, VR (Virtual Reality) screens, 3D screens and/or cinema screens.

Design and design associated parameters or definitions of the CCMBox; or of parameters or definitions of specific consumers/viewers—for CCMBoxes consumed by multiple different consumers and possibly over different presentation devices/environments (e.g. one CCMBox displayed in website X, second in website Y, and third over TV screen, each having its own design parameters); may include:
(1) The insertion of multiple CCMBoxes (e.g. visual media containers) across an article\post\web-page\document;
(2) The insertion of multiple CCMBoxes (e.g. visual media containers) across a website;
(3) The insertion of multiple CCMBoxes (e.g. visual media containers) into multiple online/offline locations, optionally allowing for various representations of the same CCMBox, automatically personalized and/or customized;
(4) Styling—various styling associated parameters of the CCMBox may be defined, including, but not limited to: color(s), dimension(s), layout, transitions, effects and/or filters;
(5) Graphic content characteristics preferences as context-wise defined by the publisher, for example an image lighting preference (i.e. exposure) for the CCMBox—(e.g. “dark photos of bridges”);
(6) Narrations about media content items in the CCMBox presented/sounded/played in concert with their respective media items;
(7) The theme of design of the CCMBox may be defined, icons/animations may be added to specific CCMBoxes or sections thereof;
(8) Various UX interfaces, layouts, skins and/or themes may be defined for a CCMBox and/or automatically selected for each device or device type presenting the CCMBox, for example, based on different size/behavior optimized for each screen size, operating system, browser, and/or other system standards;
(9) One or more media content items of a CCMBox may be defined as ‘featured’, wherein the selected ‘featured’ media item(s) representing the context of an article/blog/publication that includes the CCMBox, are presented in parent web pages, search engine results, social media content and/or other publications associated with the CCMBox including article/blog/publication; featured content items and their order may be accordingly defined as part of the CCMBox, but specific CCMBox presented content item(s) may also define their own order or feature items, and may hence override the CCMBox parameters;
(10) The order of presentation of the media content items in the CCMBox (e.g. photos, images) may be defined in advance or dynamically; and/or
(11) The CCMBox may include a design element suggesting for the CCMBox media consumer that he may contribute his own media content (e.g. photos) that may be added and possibly presented (or not) as part of future consumptions of the CCMBox content.

According to some embodiments a CCMBox may be defined/designated for a specific publication (e.g. article). According to some embodiments, a CCMBox may also be defined/designated in the form of a standalone CCMBox that may be used in additional and further publications, by the same or by other publishers.

According to some embodiments, a CCMBox embedded into a new setting/environment may retain some or all of its contextual characteristics and/or settings/definitions from a prior/other setting/environment into which it was/is embedded.

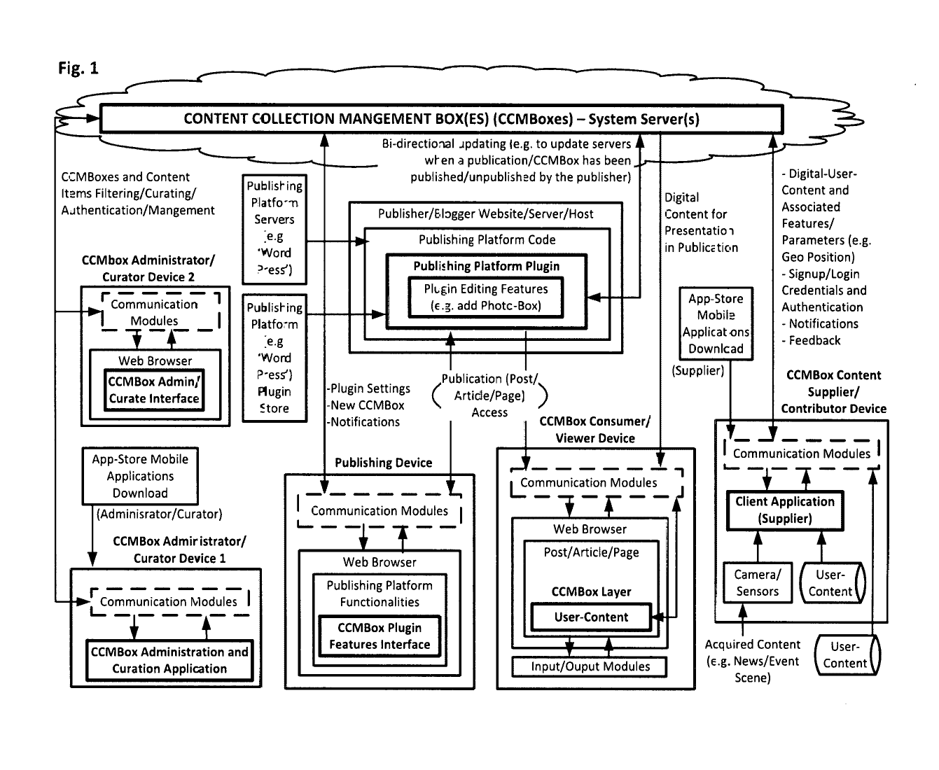

In FIG. 1 there is shown a block diagram of the operational environment of an exemplary CCMBoxes system for virtual digital content item collection, characterization, filtering, sorting, management and presentation, in accordance with some embodiments of the present invention and as further described and exemplified herein. In the figure there are shown the main entities, users and/or devices interfaced by the CCMBoxes system, including relevant modules and components thereof.

In the figure, there is shown an exemplary CCMBoxes system communicating and interfacing with the following entities, users and/or devices: a Publishing/Publisher Device, a Content Supplier/Contributor Device, two CCMBox(es) Administrator/Curator Devices and a Consumer/Viewer Device. The CCMBoxes system may include processing logics, interfaces, databases, communication modules and/or computer executable code, as further described and exemplified hereinafter.

The Publishing/Publisher Device shown includes Communication Modules and a Web Browser for accessing functionalities of a Publishing Platform, such as the publishing of digital publications, the Publishing Platform functionalities include a CCMBox Plugin Features Interface for defining CCMBoxes and embedding them into his digital publications made through the platform. Plugin settings data, new/updates-to CCMBox(es), CCMBox(es) definition/characterization data and/or notifications, are communicated between the CCMBoxes system arid the Publishing/Publisher Device.

The Publisher/Blogger Website/Server/Host shown, runs Publishing Platform Code including a Publishing Platform Plugin of the CCMBoxes system. Editing Features of the Publishing Platform Plugin allow for the publisher to define and embed CCMBoxes into his digital publications made through the platform and to manage and interface with them.

The CCMBoxes system servers may communicate with the Publishing Platform Plugin and exchange bi-directional updating to update the servers when a publication/CCMBox/digital-content-item has been published/unpublished/redefined by the publisher.

The Content Supplier/Contributor Device shown includes Communication Modules and a Content Supplier Client Application downloaded from an application store (alternatively may also interface via a web). Digital-User-Content (Acquired/Stored/Retrieved) and Associated Features/Parameters (e.g. Geo Position), Signup/Login Credentials and Authentication, Notifications and Feedback, are communicated between the CCMBoxes system and the Supplier/Contributor Device through the Application.

The first Administrator/Curator Device shown includes Communication Modules and an Administration and Curation Application downloaded from an application store. CCMBoxes and Content Items Filtering, Curating, Authentication and Management Data and Instructions are communicated between the CCMBoxes system and the Administrator/Curator Device through the Application.

The second Administrator/Curator Device shown includes Communication Modules and a Web Browser for accessing a CCMBox Administration and Curation Interface. CCMBoxes and Content Items Filtering, Curating, Authentication and Management Data and Instructions are communicated between the CCMBoxes system and the Administration and Curation Interface.

The CCMBox Consumer/Viewer Device shown includes Communication Modules and a Web Browser for accessing digital (e.g. web) publications (e.g. post, article, page) on the Publisher's website/server/host. The Web Browser presents to the Consumer/Viewer the digital publication. The presented publication includes the publishing platform code outputs—and plugin outputs which trigger: the addition of a CCMBox layer over the Web Browser presented publication and the CCMBoxes system to relay Digital Content for Presentation in the added CCMBox layer. According to some embodiments, a CCMBox may be Define/used/presented/implemented on a platform without a plugin, for example as embedded code, pulling the service from the CCMBox System Servers.

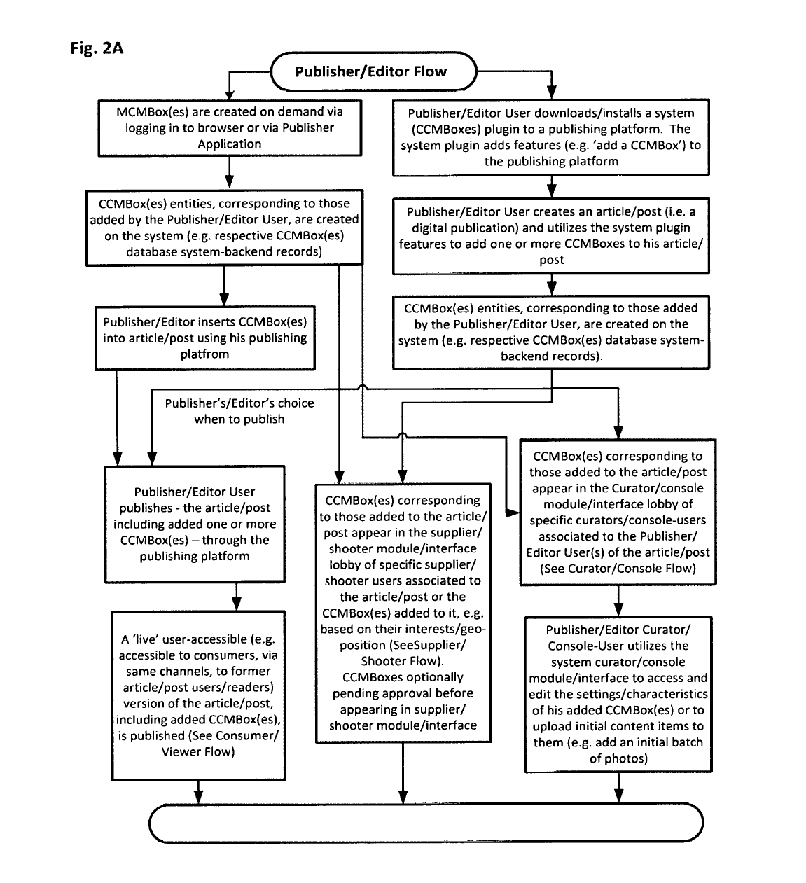

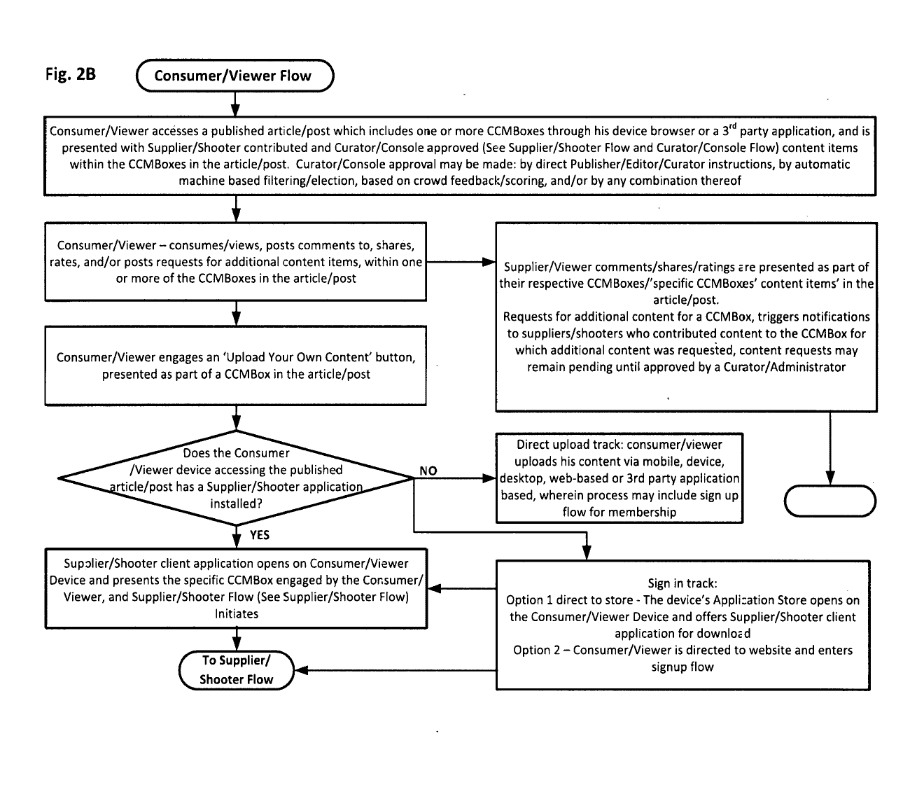

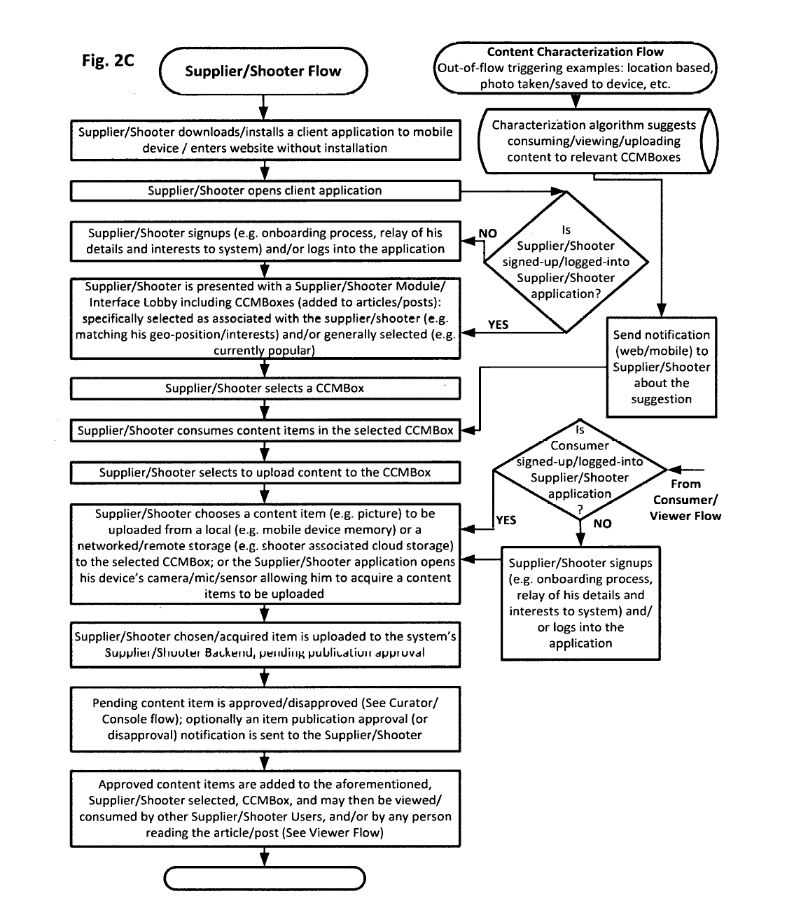

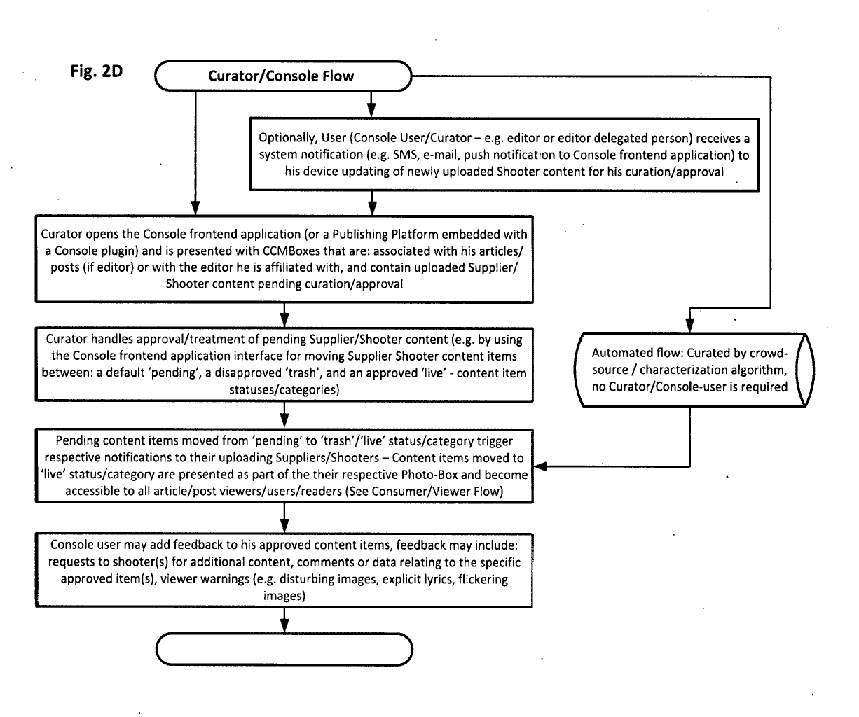

In FIGS. 2A-2D there are shown flowchart diagrams describing the main processes and operation steps, executed as part an exemplary CCMBoxes system interfacing with different entities, users and/or devices. The shown processes are executed as part of virtual digital content item collection, characterization, filtering, sorting, management and presentation, in accordance with some embodiments of the present invention and as further described and exemplified herein.

In FIG. 2A there is shown an exemplary operation flow of interfacing with a publisher/editor device. The shown steps executed as part of the process include: (1) Publisher/Editor User downloads/installs a system (CCMBoxes) plugin to a publishing platform. The system plugin adds features (e.g. ‘add a CCMBox’) to the publishing platform; (2) Publisher/Editor User creates an article/post (i.e. a digital publication) while utilizing the system plugin features to add one or more CCMBoxes to his article/post; (3) CCMBox(es) entities, corresponding to those added by the Publisher/Editor User, are created on the system (e.g. respective CCMBox(es) database system-backend records).

Based-on/Subject-to the Publisher's/Editor's choice of when to publish: (4) CCMBox(es) corresponding to those added to the article/post appear in the Curator/console module/interface lobby of specific curators/console-users associated to the Publisher/Editor User(s) of the article/post (See Curator/Console Flow); (5) Publisher/Editor Curator/Console-User utilizes the system curator/console module/interface to access and edit the settings/characteristics of his added CCMBox(es) or to upload initial content items to them (e.g. add an initial batch of photos); (6) CCMBox(es) corresponding to those added to the article/post appear in the supplier/shooter module/interface lobby of specific supplier/shooter users associated to the article/post or the CCMBox(es) added to it, e.g. based on their interests/geo-position (SeeSupplier/Shooter Flow)—CCMBoxes optionally pending approval before appearing in supplier/shooter module/interface; (7) Publisher/Editor User publishes—the article/post including added one or more CCMBox(es)—through the publishing platform (may be Based-on/Subject-to the Publisher's/Editor's choice of when to publish); and (8) A ‘live’ user-accessible (e.g. accessible to consumers, via same channels, to former article/post users/readers) version of the article/post, including added CCMBox(es), is published (See Consumer/Viewer Flow).

Alternatively, (1) MCMBox(es) are created on demand via logging in to browser (or an application); (2) CCMBox(es) entities, corresponding to those added by the Publisher/Editor User, are created on the system (e.g. respective CCMBox(es) database system-backend records); and (3) Publisher/Editor inserts CCMBox(es) into article/post using his publishing platform.

Based-on/Subject-to the Publisher's/Editor's choice of when to publish: (4) CCMBox(es) corresponding to those added to the article/post appear in the Curator/console module/interface lobby of specific curators/console-users associated to the Publisher/Editor User(s) of the article/post (See Curator/Console Flow); (5) Publisher/Editor Curator/Console-User utilizes the system curator/console module/interface to access and edit the settings/characteristics of his added CCMBox(es) or to upload initial content items to them (e.g. add an initial batch of photos); (6) CCMBox(es) corresponding to those added to the article/post appear in the supplier/shooter module/interface lobby of specific supplier/shooter users associated to the article/post or the CCMBox(es) added to it, e.g. based on their interests/geo-position (SeeSupplier/ Shooter Flow)—CCMBoxes optionally pending approval before appearing in supplier/shooter module/interface; (7) Publisher/Editor User publishes—the article/post including added one or more CCMBox(es)—through the publishing platform (may be Based-on/Subject-to the Publisher's/Editor's choice of when to publish); and (8) A ‘live’ user-accessible (e.g. accessible to consumers, via same channels, to former article/post users/readers) version of the article/post, including added CCMBox(es), is published (See Consumer/Viewer Flow).

In FIG. 2B there is shown an exemplary operation flow of interfacing with a consumer/viewer device. The shown steps executed as part of the process include: (1) Consumer/Viewer accesses a published article/post which includes one or more CCMBoxes through his device browser or a 3rd party application, and is presented with Supplier/Shooter contributed and Curator/Console approved (See Supplier/Shooter Flow and Curator/Console Flow) content items within the CCMBoxes in the article/post. Curator/Console approval may be made: by direct Publisher/Editor/Curator instructions, by automatic machine based filtering/election, based on crowd feedback/scoring, and/or by any combination thereof; and (2) Consumer/Viewer—consumes/views, posts comments to, shares, rates, and/or posts requests for additional content items, within one or more of the CCMBoxes in the article/post.

(3) The Supplier/Viewer then comments/shares/ratings are presented as part of their respective CCMBoxes/'specific CCMBoxes' content items' in the article/post; and Requests for additional content for a CCMBox, triggers notifications to suppliers/shooters who contributed content to the CCMBox for which additional content was requested, content requests may remain pending until approved by a Curator/Administrator.

In addition, (4) the Consumer/Viewer engages an ‘Upload Your Own Content’ button, presented as part of a CCMBox in the article/post; if (5) the Consumer/Viewer device accessing the published article/post has a Supplier/Shooter application installed, than (6) Supplier/Shooter client application opens on Consumer/Viewer Device and presents the specific CCMBox engaged by the ConsumerNiewer, and Supplier/Shooter Flow (See Supplier/Shooter Flow) Initiates; else, either (7) a Direct upload track is opened: consumer/viewer uploads his content via mobile, device, desktop, web-based or 3rd party application based, wherein process may include sign up flow for membership; or (8) a Sign in track is opened: Option 1 direct to store—The device's Application Store opens on the ConsumerNiewer Device and offers Supplier/Shooter client application for download, or Option 2—Consumer/Viewer is directed to website and enters signup flow, and then (6) Supplier/Shooter client application opens on ConsumerNiewer Device and presents the specific CCMBox engaged by the ConsumerNiewer, and Supplier/Shooter Flow (See Supplier/Shooter Flow) Initiates.

In FIG. 2C there is shown an exemplary operation flow of interfacing with a supplier/shooter device. The shown steps executed as part of the process include: (1) Supplier/Shooter downloads/installs a client application to mobile device/enters website without installation; (2) Supplier/Shooter opens/logs in to client application.

If (3) the Supplier/Shooter is not signed-up/logged-into Supplier/Shooter application than (4) the Supplier/Shooter signups (e.g. onboarding process, relay of his details and interests to system) and/or logs into the application; else (5) the Supplier/Shooter is directly presented with a Supplier/Shooter Module/Interface Lobby including CCMBoxes (added to articles/posts): specifically selected as associated with the supplier/shooter (e.g. matching his geo-position/interests) and/or generally selected (e.g. currently popular).

Following shown steps include: (6) Supplier/Shooter selects a CCMBox; (7) Supplier/Shooter consumes content items in the selected CCMBox (8) Supplier/Shooter selects to upload content to the CCMBox; (9) Supplier/Shooter chooses a content item (e.g. picture) to be uploaded from a local (e.g. mobile device memory) or a networked/remote storage (e.g. shooter associated cloud storage) to the selected CCMBox; or the Supplier/Shooter application opens his device's camera/mic/sensor allowing him to acquire a content items to be uploaded;

(10) Supplier/Shooter chosen/acquired item is uploaded to the system's Supplier/Shooter Backend, pending publication approval; (11) Pending content item is approved/disapproved (See Curator/Console flow); optionally an item publication approval (or disapproval) notification is sent to the Supplier/Shooter; and (12) Approved content items are added to the aforementioned, Supplier/Shooter selected, CCMBox, and may then be viewed/consumed by other Supplier/Shooter Users, and/or by any person reading the article/post (See Viewer Flow).

For a consumer/viewer user requesting to supply/contribute content items, the user is first verified: (13) is Consumer signed-up/logged-into Supplier/Shooter application; if the user is not successfully verified, he first goes through a (14) Supplier/Shooter signups (e.g. onboarding process, relay of his details and interests to system) and/or logs into the application. Either way the user is then returned to step above (9)—Supplier/Shooter chooses a content item (e.g. picture) to be uploaded from a local (e.g. mobile device memory) or a networked/remote storage (e.g. shooter associated cloud storage) to the selected CCMBox; or the Supplier/Shooter application opens his device's camera/mic/sensor allowing him to acquire a content items to be uploaded.

Further shown in the figure is (15) a Content Characterization Flow process entry based on Out-of-flow triggering examples: location based, photo taken/saved to device, etc.; wherein: (16) Characterization algorithm suggests consuming/viewing/uploading content to relevant CCMBoxes; and (17) Respective notifications are issued (web/mobile) to Suppliers/Shooters about the suggestion. The notified Suppliers/Shooters are then integrated into the shown process in step (7) (Supplier/Shooter consumes content items in the selected CCMBox).

In FIG. 2D there is shown an exemplary operation flow of interfacing with a curator/console device. The shown steps executed as part of the process include: (1) Curator opens the Console frontend application (or a Publishing Platform embedded with a Console plugin) and is presented with CCMBoxes that are: associated with his articles/posts (if editor) or with the editor he is affiliated with, and contain uploaded Supplier/Shooter content pending curation/approval; the user (Console User/Curator—e.g. editor or editor delegated person) may optionally first (2) receive a system notification (e.g. SMS, e-mail, push notification to Console frontend application) to his device updating of newly uploaded Shooter content for his curation/approval.

Following steps include: (3) Curator handles approval/treatment of pending Supplier/Shooter content (e.g. by using the Console frontend application interface for moving Supplier Shooter content items between: a default ‘pending’, a disapproved ‘trash’, and an approved ‘live’—content item statuses/categories); (4) Pending content items moved from ‘pending’ to ‘trash’/'live' status/category trigger respective notifications to their uploading Suppliers/Shooters—Content items moved to ‘live’ status/category are presented as part of the their respective Photo-Box and become accessible to all article/post viewers/users/readers (See ConsumerNiewer Flow); and (5) Console user may add feedback to his approved content items, feedback may include: requests to shooter(s) for additional content, comments or data relating to the specific approved item(s), viewer warnings (e.g. disturbing images, explicit lyrics, flickering images).

Alternatively, (6) an automated flow may be triggered, wherein content is curated by crowd-source/characterization algorithm and no Curator/Console-user is required, the process is then continued from step (4).

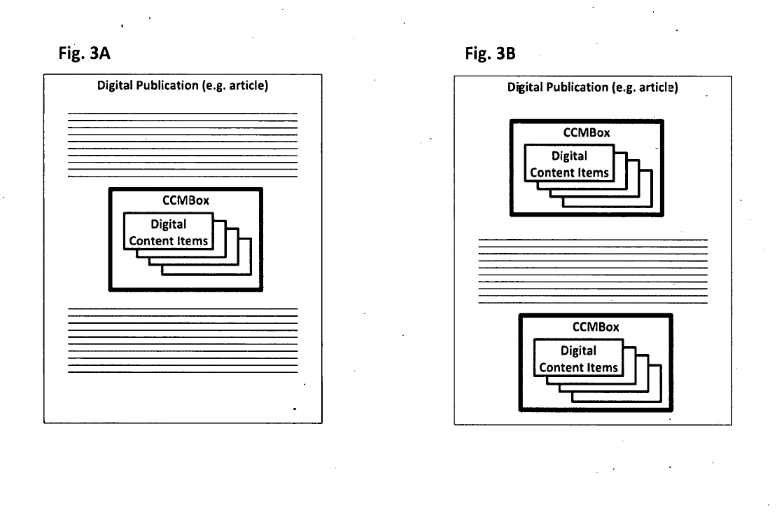

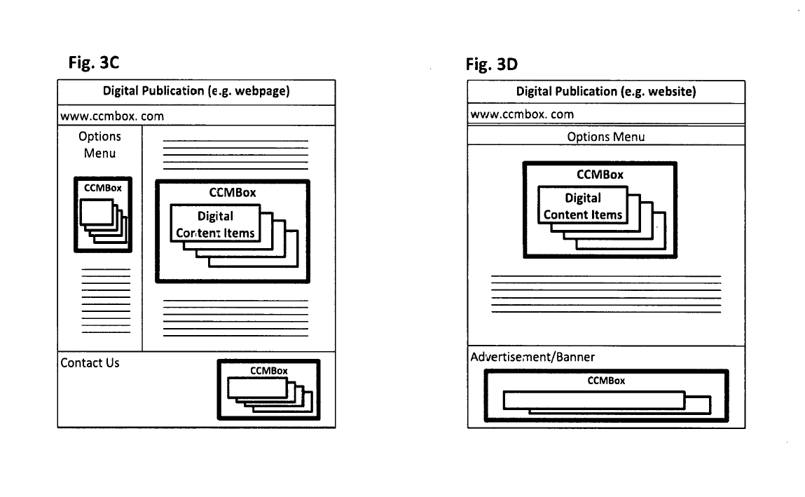

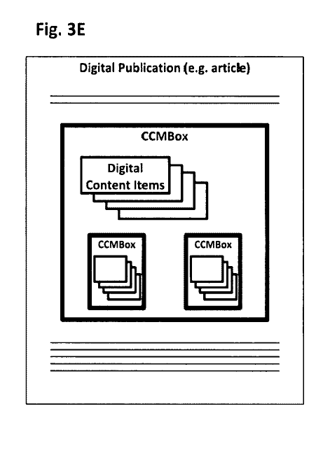

In FIGS. 3A-3E there are shown schematic examples of presentation arrangements, layouts, positioning and object interactions of CCMBoxes embedded into digital publications (e.g. webpage, article, post), in accordance with some embodiments of the present invention and as further described and exemplified herein.

In FIG. 3A there is shown a CCMBoxes embedded into a text publication; In FIG. 3B there are shown multiple CCMBoxes embedded into a text publication; In FIG. 3C there is shown a CCMBoxes embedded into a webpage; In FIG. 3D there are shown multiple CCMBoxes embedded into a website; and In FIG. 3E there are shown multiple CCMBoxes, wherein multiple CCMBoxes are embedded into another CCMBox that is embedded in a text publication.

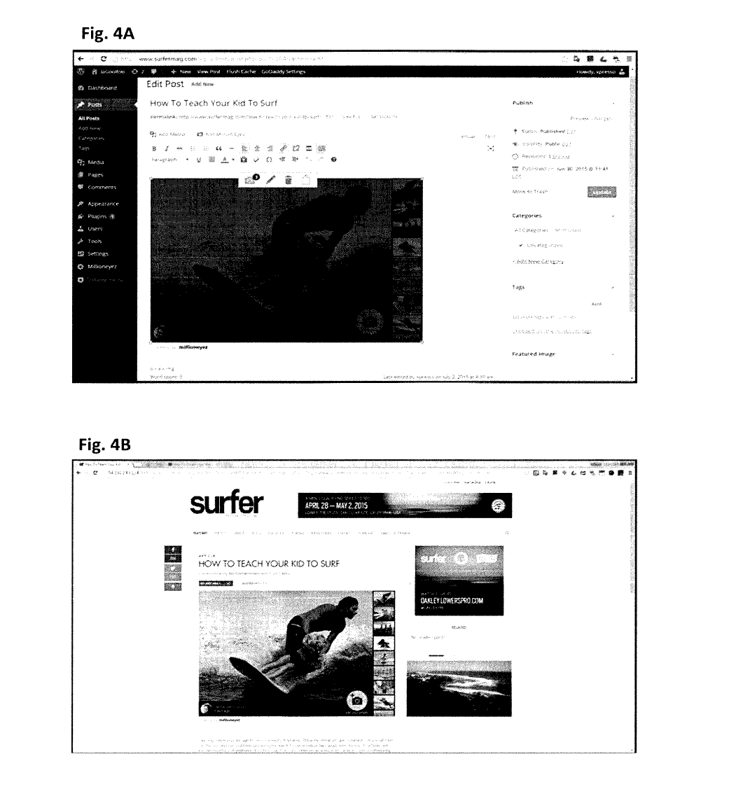

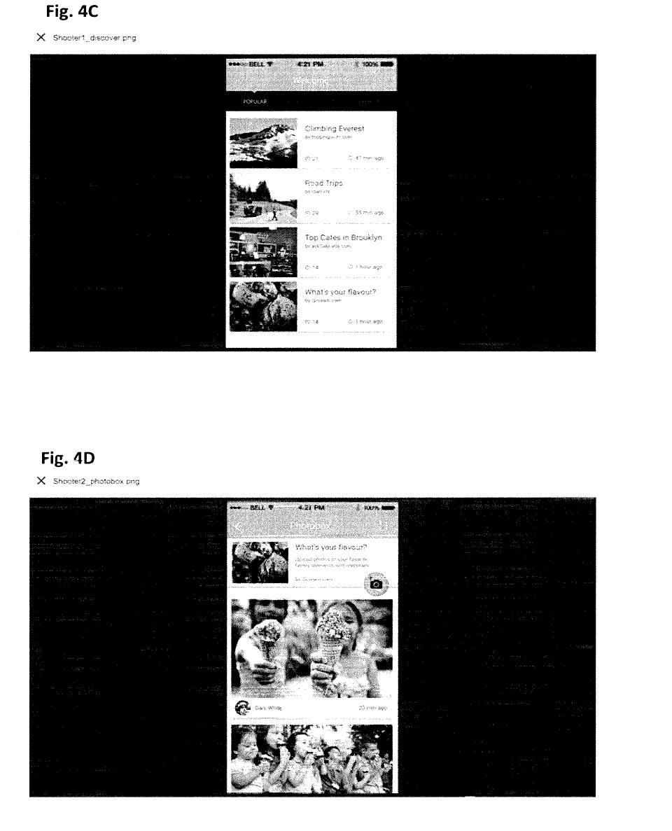

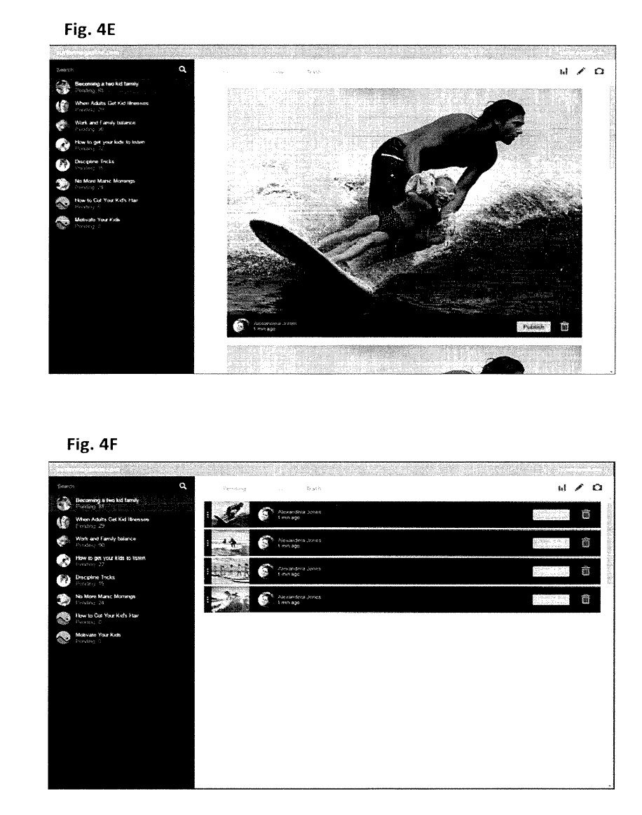

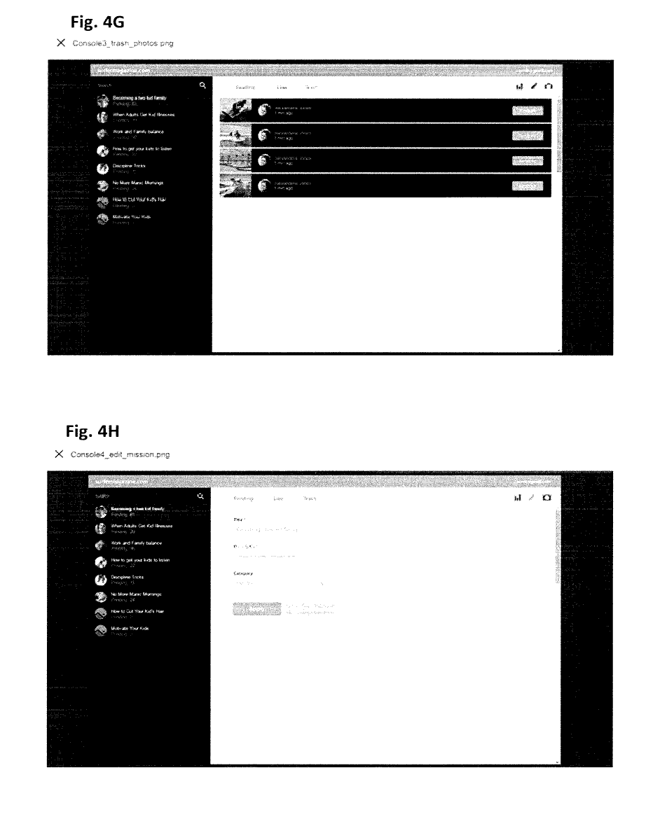

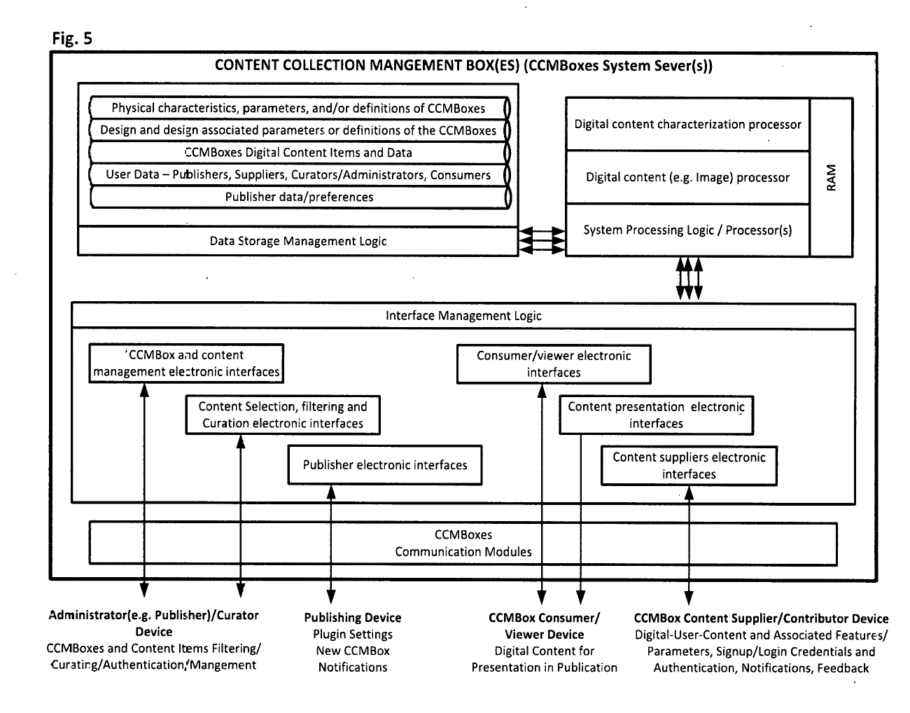

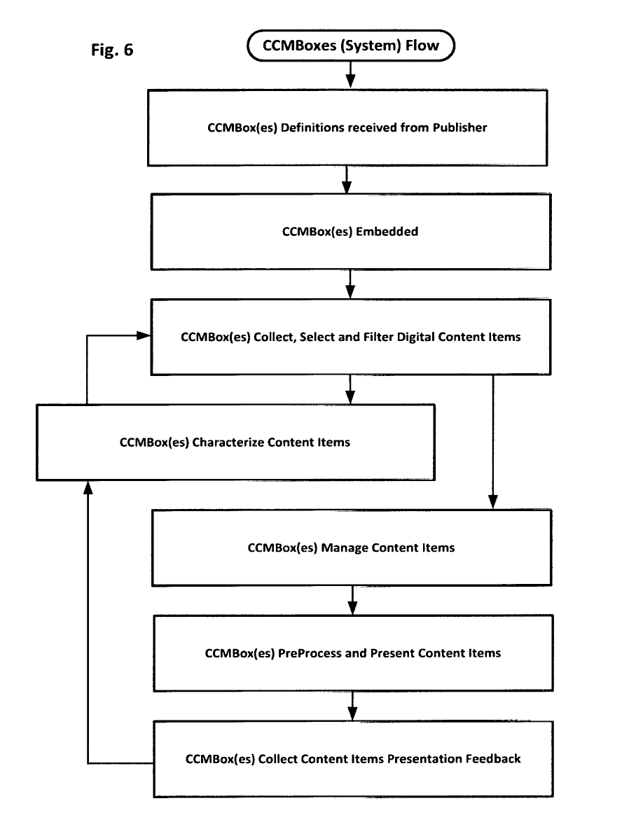

In FIGS. 4A-4H there are shown screenshots of system applications' graphic user interfaces, of an exemplary CCMBoxes system, in accordance with some embodiments of the present invention and as further described and exemplified herein.

FIG. 4A, shows an exemplary user interface of a publishing platform onto which a Publisher/Editor-Module has been installed and respective Publisher/Editor-Module features/functionalities, such as the addition of CCMBoxes, were thus added, in accordance with some embodiments of the present invention.

FIG. 4B, shows an exemplary user interface of a ConsumerNiewer, viewing a digital publication including an Editor-User added CCMBox and user content uploaded to it, in accordance with some embodiments of the present invention.

FIG. 4C, shows an exemplary user interface of a Supplier/Shooter-Module-Lobby, wherein Publisher/Editor-User added CCMBox(es) to which user content may be uploaded are presented to a Shooter-User, in accordance with some embodiments of the present invention; and FIG. 4D, shows an exemplary user interface of a CCMBox, wherein a specific Editor-User added CCMBox was accessed by a Shooter-User, in accordance with some embodiments of the present invention.

FIG. 4E, shows an exemplary user interface of a Curator/Console-Module, wherein pending content items, awaiting curation/approval, are presented to a Console-User, in accordance with some embodiments of the present invention; FIG. 4F, shows an exemplary user interface of a Console-Module, wherein live content items, currently being presented to Viewers accessing live digital publications, are presented to a Console-User, in accordance with some embodiments of the present invention; FIG. 4G, shows an exemplary user interface of a Console-Module, wherein trashed/disapproved content items, previously elected as non-eligible or unwanted for presentation, are presented to a Console-User, in accordance with some embodiments of the present invention; and FIG. 4H, shows an exemplary user interface of a Console-Module, wherein information, pertaining to a specific content items of a selected CCMBoxes, is edited, in accordance with some embodiments of the present invention.

In FIG. 5 there is shown a block diagram of an exemplary CCMBoxes system for virtual digital content item collection, characterization, filtering, sorting, management and presentation, in accordance with some embodiments of the present invention and as further described and exemplified herein. In the figure there are shown the main components, processors, interfaces, and databases utilized by the CCMBoxes system and the interconnections and relations of the components, processors, interfaces, and databases.

The exemplary CCMBoxes system includes: a Data Storage Management Logic for managing the storage and retrieval of data to the shown databases; an Interface Management Logic for controlling the operation of the shown interfaces; and a Central Processor with an Operation Memory (e.g. RAM) for controlling the operation of the Management Logics and Communication Modules of the CCMBoxes system.

The shown Interfaces include:
(1) CCMBox and content management electronic interfaces, and (2) Content Selection, filtering and Curation electronic interfaces, for interfacing with Administrator(e.g. Publisher)/Curator Devices and for communicating CCMBoxes and Content Items related: Filtering, Curating, Authentication and Management parameters;
(3) Publisher electronic interfaces for interfacing with Publishing/Publisher Devices and for communicating Plugin Settings. New CCMBox and CCMBox definitions and Notifications;
(4) Consumer/viewer electronic interfaces for interfacing with CCMBox Consumer/Viewer Devices and for communicating: Digital Content for Presentation in consumed/viewed Publications, Notifications and Feedback;
(5) Content presentation electronic interfaces for interfacing with CCMBox ConsumerNiewer Devices and for communicating Digital Content Presentation parameters and instructions, for CCMBox(es) and Digital Content presentation within a digital Publication; and
(6) Content suppliers electronic interfaces for interfacing with CCMBox Content Supplier/Contributor Devices and for communicating Digital-User-Content items, as candidates for inclusion in specific/requested CCMBox(es) and Associated Features/Parameters, Signup/Login Credentials and Authentication, Notifications and Feedback.
   The shown Databases include:
(1) a CCMBoxes Physical characteristics, parameters, and/or definitions database and (2) a CCMBoxes Design parameters or definitions database—for storing all system and user(s) records of CCMBoxes settings;
(3) a CCMBoxes Digital Content Items and Parameters database—for storing all Supplier/Shooter CCMBoxes digital content items and corresponding associated data; and
(4) a User Records database—for storing user records, history, credentials, settings and preferences.
   The Digital content characterization processor shown, generates digital content items matchings and recommendations/suggestions based on rating and tagging it of content items. The content items are rated and tagged based on content associated language/text and users' reaction/interaction to/with it. It is described in further detail in FIG. 3A. The Digital content (e.g. Image) processor shown, improves or modifies digital content items, prior to their presentation to consumers/viewers within an CCMBox(es).

In FIG. 6 there is shown a flowchart diagram of the main operation steps and process, executed by an exemplary CCMBoxes system for virtual digital content item collection, characterization, filtering, sorting, management and presentation, in accordance with some embodiments of the present invention and as further described and exemplified herein.

The shown steps executed as part of the process include: (1) Defining and Embedding CCMBox(es); (2) Collecting, Selecting and Filtering Digital Content Items for CCMBox(es); (3) Characterizing Content Items of CCMBox(es); (4) Managing the Content Items in the CCMBox(es); (5) Pre Processing and Presenting Content Items of the CCMBox(es) ; and (6) Collecting Content Items Presentation Feedback of the CCMBox(es).

(3) Characterizing results of Content Items are returned to step (2) for further Collecting, Selecting, Filtering and Suggestion of Digital Content Items for CCMBox(es). Results of (6) Collecting Content Items Presentation Feedback of the CCMBox(es) are relayed back to step (3) the Characterizing results of Content Items, for further Characterization of content items based on the collected feedbacks.

According to some embodiments, a CCMBox may comprise one or more electronic interfaces for communicating over a data network (e.g. the Internet) with digital content suppliers. The CCMBox may include electronic interfaces that may be used for receiving from the digital content suppliers, candidate digital content for the CCMBox. According to some embodiments, digital content suppliers may be selected/filtered based on any relevant criteria.

According to some embodiments, a CCMBox may include interfaces and/or virtual frameworks for facilitating communication between digital content suppliers and administrators of CCMBoxes (e.g. the publisher of the article). A CCMBox may be further designed to facilitate communication in direct association with a digital item or a set of digital items.

According to some embodiments, digital content suppliers may communicate with publishers of articles/blogs/publications including CCMBox(es) (e.g. publishers which selected them as content suppliers for their publication's CCMBox(es)) possibly within the context of a specific CCMBox. digital content suppliers may upload media content items to one or more CCMBox(es), either as candidate items or for direct presentation on CCMBoxes for which the media content suppliers have already been selected.

According to some embodiments, a CCMBox may comprise one or more electronic interfaces for receiving selection or filtering parameters of media content suppliers, for providing digital content to the CCMBox over a data network.

Content media items suppliers/contributors may be selected, filtered, categorized, segmented and/or rated, either: manually—wherein suppliers/contributors are handpicked either by the publisher/editor and/or are invited by already existing content supplier(s) or viewer(s) of a given CCMBox; and/or based on a rating and/or category—wherein suppliers/contributors are automatically, semi-automatically, and/or manually selected based on their rating and category.

Content suppliers/contributors may start as onboarding unrated media contributors (e.g. from web\traffic\active search), slowly building their rating as they go. Rating may initially be given manually, may be built over time/traffic into a crowdsourced rating as additional Crowd (e.g. viewers, contributors, publishers, others) ratings accumulate, and/or may be calculated/determined automatically by an algorithm (e.g. examining the history of the levels of quality of items provided by a given media items supplier/contributor and comparing to those of other supplier/contributor) that may, or may not, take into consideration crowdsourced and/or manual ratings previously associated with the same supplier/contributor

According to some embodiments, a CCMBox may comprise one or more electronic interfaces for selecting/filtering and/or for receiving selections or filtering parameters, over a data network, of media content items candidates for possible inclusion and presentation as part of its content.

According to some embodiments, automatic selection/filtering/rating of media content items (also referred to as ‘automatic curation’) may consist of a crowd sourced method, including: (1) determining if the user/rater of a given content item is a legitimate user, by letting him/her rate, characterize, categorize or choose (e.g. choose best) item(s) from a pre-rated media content items set and see if he makes legitimate ratings/choices (e.g. beneath a threshold ‘distance’ value from the average ratings/choices value); (2) creating an interactive “game” of presenting several content items; and letting the user(s) pick the best/favorite ones, and\or letting the user rate a certain specific content item or specific set of content items [step 1 may be executed as part of step 2] wherein users/raters are initially approved and only then used for actual media item rating; and/or (3) if enough users pick the content item(s) in test, or gives it/them a high enough rating—corresponding media item(s) may be automatically published within the respective CCMBox(es).

According to some embodiments, a variation of the crowd sourced method for rating content items may request rating/curating users in the crowd to select (independently, or based on an option list) a word or words that best describe/match each of a set of one or more candidate media items (funny/sad/not relevant etc.). Alternatively, tagged media items being rated may be compared to, and receive ratings based on, those already given to similarly tagged media items.

According to some embodiments, a further variation of the crowd sourced method for rating content items may enable straightforward curation, wherein already known and legitimate/approved users (e.g. media items consumers, media items suppliers/contributors) are requested to curate candidate media content items of other suppliers/contributors by providing a binary feedback (e.g. yes/no, good/bad, high/low quality, matches/does-not-match context of CCMBox and associated text publication).

According to some embodiments, automatic selection/filtering of media content items (also referred to as ‘automatic curation’) may consist of an algorithm based method, wherein media content items may be automatically approved for presentation as part of a corresponding CCMBox. Auto-approved/curated media items may be approved for presentation subject to: (1) their supplier/contributor is highly rated, or flagged, as OK for auto-approval uploads, by CCMBox administrator/publisher/editor or other delegated person, (2) the content item has been previously approved for presentation on another/other CCMBox(es), and/or (3) the supplier/contributor has been linked to a known account (e.g. by email address, phone number, other unique identifier) and approved/designated for auto-curation and approval of his uploaded media items.

According to some embodiments, manual selection/filtering/rating of media content items (also referred to as ‘manual curation’) may consist of curation/approval of CCMBox media content items by the publisher of the CCMBox containing article/blog/publication, wherein the publisher selects, filters, and/or rates media items uploaded by media suppliers/contributors as candidates to his published CCMBox.

According to some embodiments, semi-automatic selection/filtering/rating of media content items (also referred to as ‘semi-automatic curation’) may consist of: (1) applying one or more automatic selection/filtering/rating schemes as described above; (2) Presenting to a curator(s) of the CCMBox a subset of media items automatically selected from within the candidate items; and/or (3) receiving the manual subset selections of the curator(s) and approving them for presentation within the corresponding CCMBox;

According to some embodiments, semi-automatic selection/filtering/rating of media content items may consist of building, based on automatic media content items approval tool outputs and/or based on previously manually approved media content items (e.g. publisher approved), a database/reservoir/corpus of pre-approved media items, optionally giving higher weight to verified/certified/previously-known curators, and approving for CCMBox media items publication based thereof (e.g. items already in the database are automatically approved for publication).

According to some embodiments, the CCMBox may facilitate, through its electronic interfaces for communicating over a data network (e.g. the Internet), communications between the Publisher or Curator of a CCMBox and its media content items Suppliers/Contributors. Publisher-Supplier communication may facilitate a CCMBox collaborative media items selection and filtering process. The collaborative process may allow a per item discussion/opinion-sharing, wherein a given media item may need to receive both: its owner's (supplier's/contributor's) and its intended CCMBox publisher's/curator's consent, prior to its approval for presentation, or upon declining its presentation.

According to some embodiments, electronic interfaces of the CCMBox, facilitating the communication between the Publisher or Curator of a CCMBox and its media content items Suppliers/Contributors, may include a chat like user interface for providing bi-directional feedback or suggestions in regard to candidate media items considered for publication within a given CCMBox. According to some embodiments, a subset of definitions or characteristics (e.g. visual/graphic appearance—for example cropping/effects) of a media item candidate may be editable/updatable by each of the parties (the Publisher and the Supplier), with or without the other party's approval.

According to some embodiments, definitions or characteristics editable/updatable by each of the parties, may nevertheless, be presented only: with the approval of both/all parties, if under the terms of use, if there is no risk of infringement of content copyrights and\or if they do not override (some or all of) the definitions of the CCMBox settings.

According to some embodiments, the CCMBox may facilitate, through its electronic interfaces for communicating over a data network (e.g. the Internet), communications between different Consumers/Viewers of a CCMBox and its media content items. The electronic (communication) interfaces may facilitate the communication of posts and messages between content consumers of the same CCMBox/Content-Items and/or corresponding content suppliers and publishers. Communicated posts/messages may be replied to, or voted/commented on by other users (contributors/publishers/consumers).

According to some embodiments, the history of communication between the users/parties in the context of a specific, or a group of, CCMBox(es) and the history of changes/modifications made to the CCMBox(es) and/or to its candidate/approved media items, may be saved for future reference or restoration.

According to some embodiments, the CCMBox may comprise an API (Application Programming Interface) enabling programmers/application-creators to develop and interface their own games/programs/applications for the selection, tagging, rating, and/or possibly modifying, of media items for CCMBox presentation.

According to some embodiments, as part of a collaborative media content items selection/filtering/rating process, a CCMBox may receive through a consumer/viewer interface digital items or item types suggested/requested (e.g. described) by the consumers/viewer as appropriate/matching the CCMBox. Multiple consumers/viewers may suggest and vote up their preferred items, collectively forming a media-item-wish that may be relayed to the publisher/curator and substitute the media items selection/filtering/rating process, or assist it.

According to some embodiments, a CCMBox may comprise one or more processors for automatic digital content characterization based on natural language processing of context and feedback and the automated monitoring of user computer action/reaction relating to the digital content.

Digital content characterization may include the rating and tagging of: digital content items, digital content items collections (CCMBoxes) and the different users interfacing with them. Based on the ratings and tags, matchings between: digital content items, CCMBox(es) and system users, may be made. And various digital content associated suggestions/recommendations may be generated.

According to some embodiments, systems and methods for characterization of content items may examine: (1) a context/surrounding/environment, associated with each content item or (2) data relating to each context item (including text, documents, web pages, other images and so on) to derive characterization parameters and/or tags relating to the respective content item. For example, an image in a surfing webpage may receive a tag #surf, or each image in a CCMBox associated with an article about surfing may receive the tag #surf. Similarly, each image in a given CCMBox may be characterized as matching the tastes/standards of curator x that selected the images for the given CCMBox.

According to some embodiments, as implied in the example above, after digital content items have been approved/included in a CCMBox, context/setting/environmental parameters of the CCMBox may be analyzed to derive characterization parameters and/or tags relating to the digital content items within the CCMBox. For example, all images approved for a CCMBox appearing in an article of romantic sunsets may receive the tag #romantic. Similarly, other parameters of the CCMBox may be analyzed to derive characterization parameters and/or tags relating to the respective digital content items. As suggested above, the identity of a curator of the CCMBox may aid to characterize/rate images in the CCMBox. Viewing parameters of the CCMBox may also be used to characterize the images in the CCMBox.

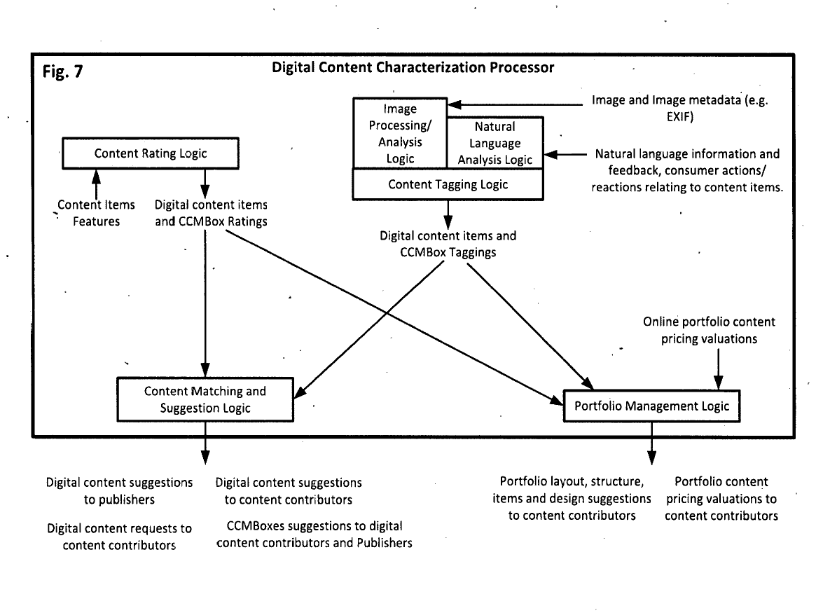

In FIG. 7 there is shown a block diagram of a Digital Content Characterization Processor of an exemplary CCMBoxes system, in accordance with some embodiments of the present invention and as further described and exemplified herein. In the figure, there are shown the different processing logics of the Digital Content Characterization Processor, the information flow and exchange between the processing logics and their main inputs and outputs.

The Content Rating Logic shown, generates Digital content items and CCMBox(es) Ratings based on received Content Items Features. The Content Tagging Logic also generates Digital content items and CCMBox Taggings, utilizing a Natural Language Analysis Logic to analyze Natural language information and feedback and consumer actions/reactions relating to content items.

The generated ratings and taggings are processed by a Content Matching and Suggestion Logic to generate: Digital content suggestions to publishers, Digital content requests to content contributors, Digital content suggestions to content contributors and CCMBoxes suggestions to digital content contributors.

The generated ratings and taggings are processed by a Portfolio Management Logic to generate: Portfolio layout, structure, items and design suggestions to content contributors and Portfolio content pricing valuations to content contributors.

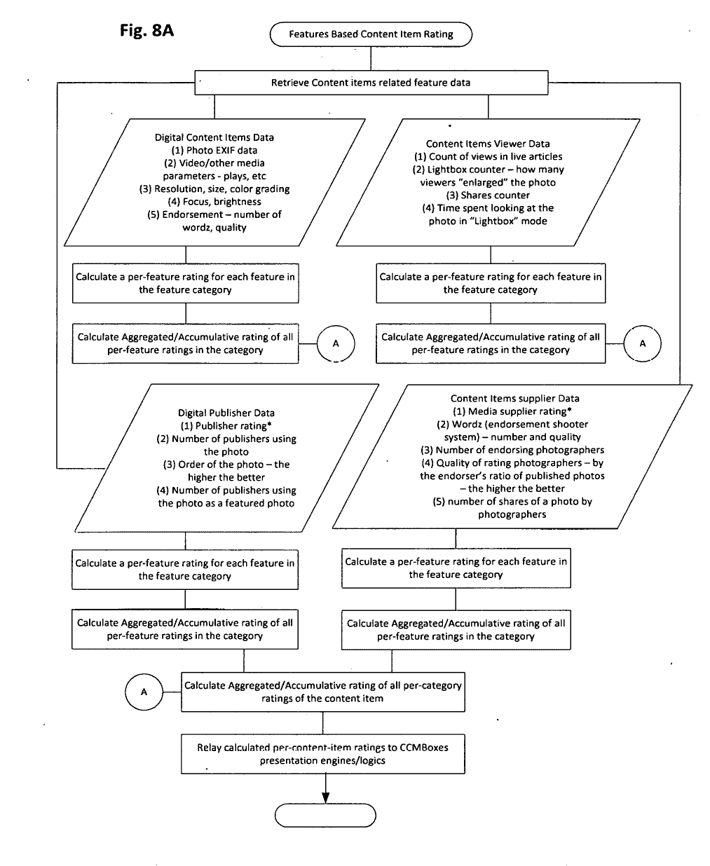

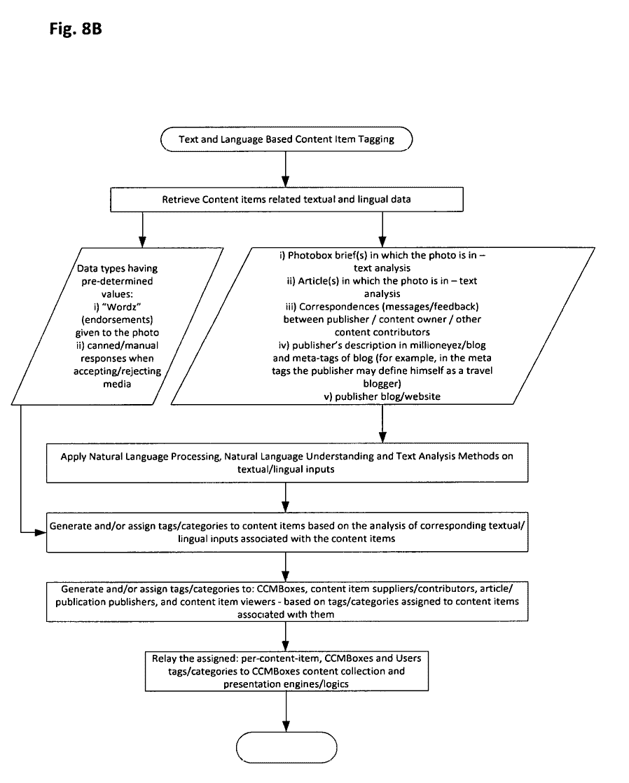

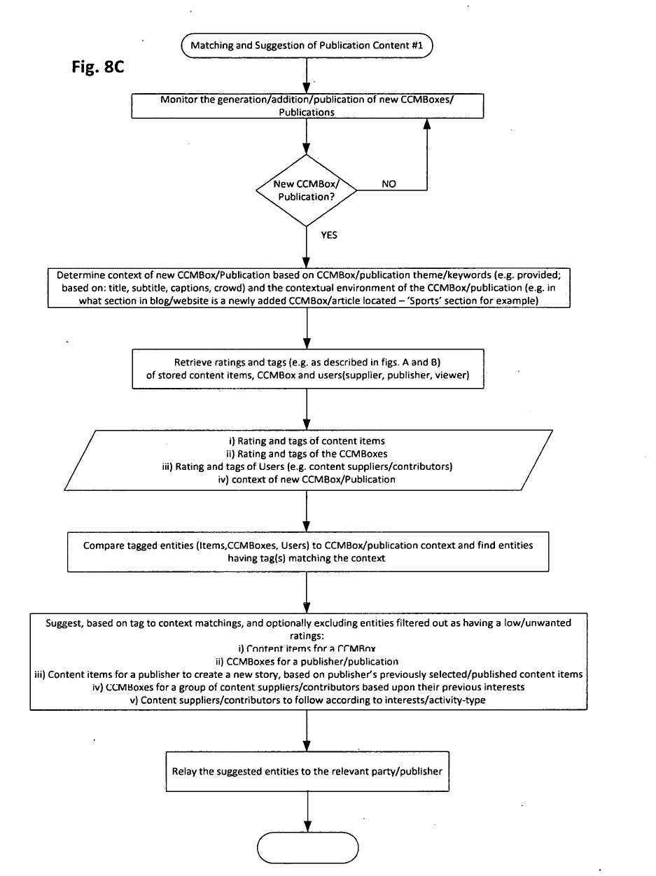

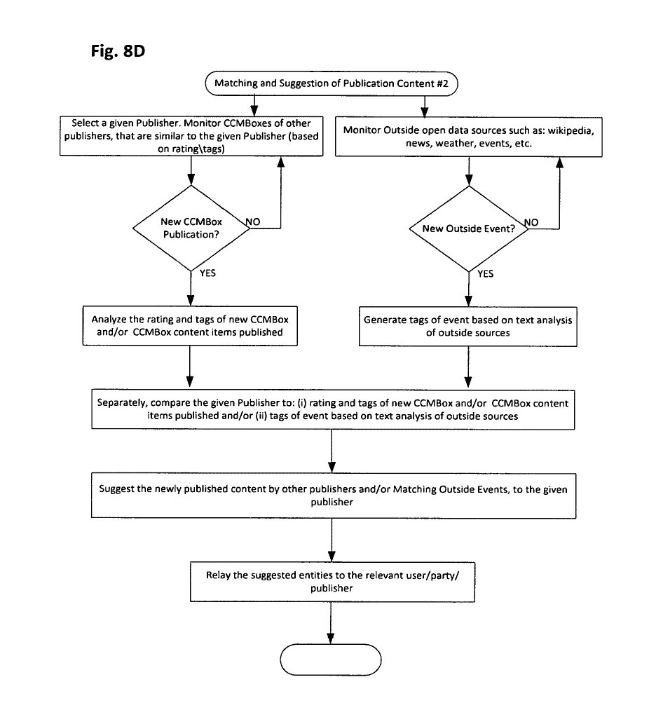

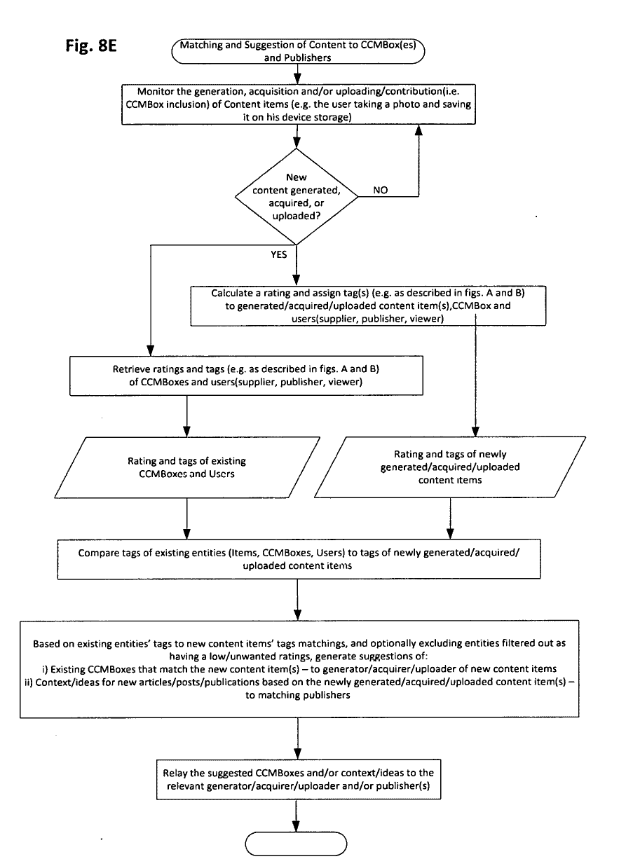

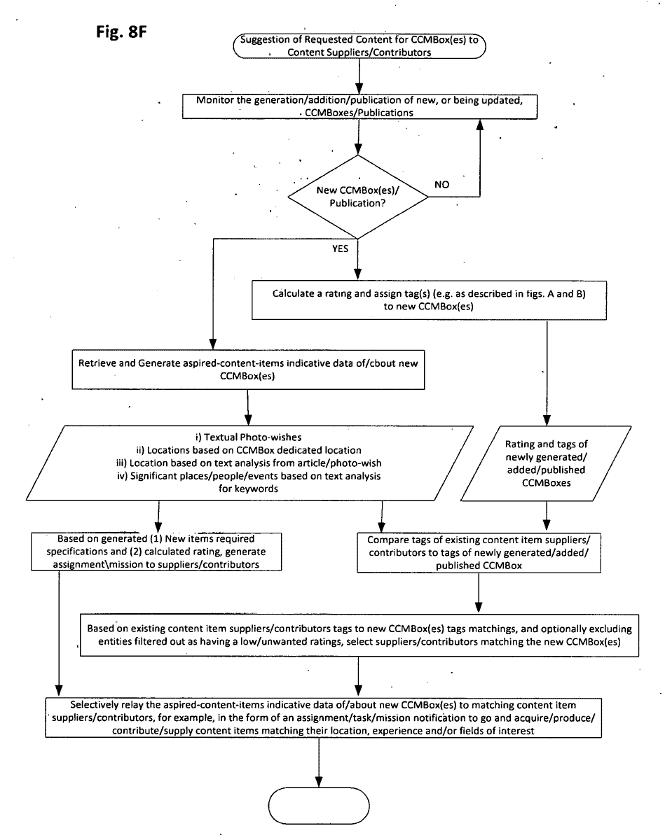

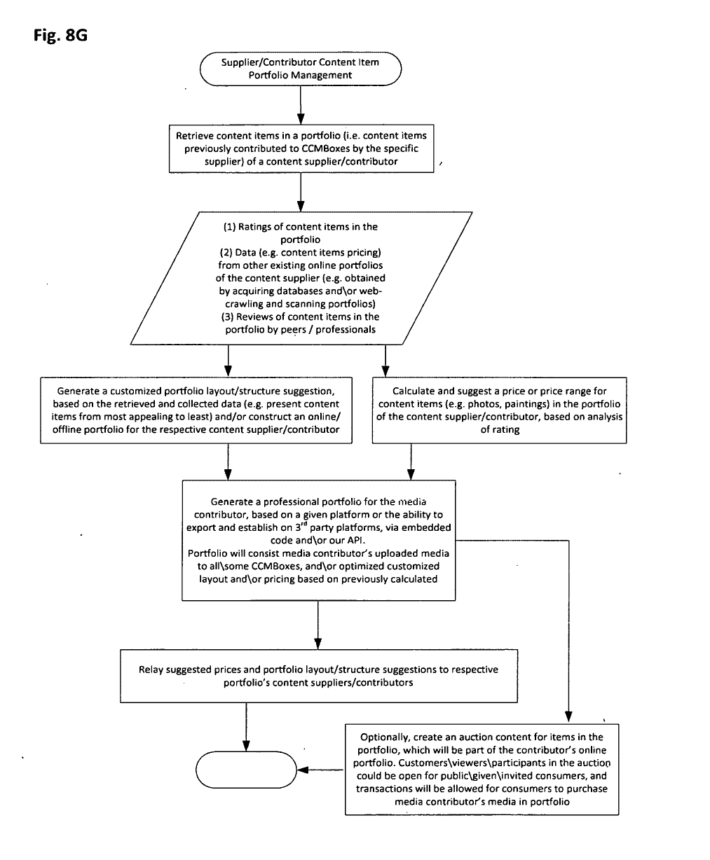

In FIGS. 8A-8G there are shown flowchart diagrams describing the main processes and operation steps, executed by a Digital Content Characterization Processor of an exemplary CCMBoxes system, in accordance with some embodiments of the present invention and as further described and exemplified herein. Digital content characterization processes shown include rating, tagging, matching and suggestion of digital content and digital content items.

According to some embodiments, a Digital Content Characterization Processor of an exemplary CCMBoxes system may execute a Features Based Content Item Rating process. An exemplary Features Based Content Item Rating process may include some or all of the following operation steps and flow:
(1) Retrieve Content items related feature data, including:
(a) Digital (Category) Content Items Data: (i) Photo EXIF data, (ii) Video/other media Parameters—plays, etc., (iii) Resolution, size, color grading, (iv) Focus, brightness and/or (v) Endorsement—number of words, quality of endorsement;
(b) Content Items Viewer (Category) Data: (i) Count of views in live articles, (ii) Lightbox Counter—how many viewers “enlarged” the photo, (iii) Shares counter and/or (iv) Time spent looking at the photo in “Lightbox” mode;
(c) Digital Publisher (Category) Data: (i) Publisher rating, (ii) Number of publishers using the photo, (iii) Order of the item/photo—the higher the better, (iv) Number of publishers using the photo as a featured item/photo; and/or
(d) Content Items supplier (Category) Data: (i) Media supplier rating, (ii) Wordz (endorsement supplier/shooter system)—number and quality, (iii) Number of endorsing photographers, (iv) Quality of rating photographers—by the endorser's ratio of published photos—the higher the better and/or (v) number of shares of a photo by photographers.
(2) Calculate a per-feature rating for each feature in each of the feature categories.
(3) Calculate Aggregated/Accumulative rating of all per-feature ratings for each of the feature categories.
(4) Calculate Aggregated/Accumulative rating of all per-category ratings of the content item.
(5) and Relay calculated per-content-item ratings to CCMBoxes presentation interfaces/engines/logics and/or to any other of its interfaces/logics/processors.

In FIG. 8A there is shown a flowchart diagram describing the main processes and operation steps, executed by a Digital Content Characterization Processor, as part of a process for Features Based Content Item Rating.

According to some embodiments, a Digital Content Characterization Processor of an exemplary CCMBoxes system may execute a Text and Language Based Content Item Tagging process. An exemplary Text and Language Based Content Item Tagging process may include some or all of the following operation steps and flow:
(1) Retrieve Content items related textual and lingual data.
(2) Apply Natural Language Processing, Natural Language Understanding and Text Analysis Methods on textual/lingual inputs including: (i) Photobox brief(s) in which the photo is in—text analysis; (ii) Article(s) in which the photo is in—text analysis; (iii) Correspondences (messages/feedback) between publisher/content owner/other content contributors; (iv) publisher's description in millioneyez/blog and meta-tags of blog (for example, in the meta tags the publisher may define himself as a travel blogger); and/or (v) publisher blog/website.
(3) Generate and/or assign tags/categories to content items based on the analysis of corresponding textual/lingual inputs associated with the content items. Generate and/or assign tags/categories to: (A) step 2 outputs; and/or directly (skipping step 2) to textual/lingual inputs, of data types having pre-determined values, including (i) “Wordz” (endorsements) given to the photo and/or (ii) canned/manual responses when accepting/rejecting media.
(4) Generate and/or assign tags/categories to: CCMBoxes, content item suppliers/contributors, article/publication publishers, and content item viewers—based on tags/categories assigned to content items associated with them.
(5) and Relay the assigned: per-content-item, CCMBoxes and Users tags/categories to CCMBoxes content collection and presentation engines/logics/interfaces.

In FIG. 8B there is shown a flowchart diagram describing the main processes and operation steps, executed by a Digital Content Characterization Processor, as part of a process for Text and Language Based Content Item Tagging.

According to some embodiments, a Digital Content Characterization Processor of an exemplary CCMBoxes system may execute a First Matching and Suggestion of Publication Content process. An exemplary First Matching and Suggestion of Publication Content process may include some or all of the following operation steps and flow:
(1) Monitor the generation/addition/publication of new CCMBoxes/Publications.
(2) Upon a new CCMBox/Publication generation/addition/publication—Determine context of new CCMBox/Publication based on CCMBox/publication theme/keywords (e.g. provided; based on: title, subtitle, captions, crowd) and the contextual environment of the CCMBox/publication (e.g. in what section in blog/website is a newly added CCMBox/article Located—‘Sports’ section for example).
(3) Retrieve ratings and tags (e.g. as described in FIGS. 8A and 8B) of stored content items, CCMBox and users(supplier, publisher, viewer). Retrieved ratings and tags may include: (i) Rating and tags of content items, (ii) Rating and tags of the CCMBoxes, (iii) Rating and tags of Users (e.g. content suppliers/contributors) and/or (iv) context of new CCMBox/publication.
(4) Compare tagged entities (Items,CCMBoxes, Users) to CCMBox/publication context and find entities having tag(s) matching the context.
(5) Suggest, based on tag to context matchings, and optionally excluding entities filtered out as having a low/unwanted ratings: (i) Content items for a CCMBox, (ii) CCMBoxes for a publisher/publication, (iii) Content items for a publisher to create a new story, based on publisher's previously selected/published content items, (iv) CCMBoxes for a group of content suppliers/contributors based upon their previous interests and/or (v) Content suppliers/contributors to follow according to interests/activity-type.
(6) and Relay the suggested entities to the relevant party/publisher.

In FIG. 8C there is shown a flowchart diagram describing the main processes and operation steps, executed by a Digital Content Characterization Processor, as part of a first process for Matching and Suggestion of Publication Content.

According to some embodiments, a Digital Content Characterization Processor of an exemplary CCMBoxes system may execute a Second Matching and Suggestion of Publication Content process. An exemplary Second Matching and Suggestion of Publication Content process may include some or all of the following operation steps and flow:

### In Parallel:

(1) Select a given Publisher. Monitor CCMBoxes of other publishers, that are similar to the given. Publisher (based on rating\tags).
(2) Upon a New CCMBox Publication, Retrieve/Generate/Analyze the rating and tags of new CCMBox and/or CCMBox content items published. And:
(1′) Monitor Outside open data (e.g. text) sources such as: wikipedia, news, weather, events, etc.
(2′) Upon detecting a New ‘Outside Event’ (e.g. news headline), Generate tags based on text analysis of outside sources text, related to the Event.

### Then:

(3) Compare tagged CCMBox/publications to tagged outside events. Separately, compare the given Publisher to: (i) rating and tags of new CCMBox and/or CCMBox content items published and/or (ii) tags of event based on text analysis of outside sources.
(4) Suggest the newly published content by other publishers and/or Matching Outside Events, to the given publisher.
(5) and Relay the suggested entities to the relevant user/party/publisher.

In FIG. 8D there is shown a flowchart diagram describing the main processes and operation steps, executed by a Digital Content Characterization Processor, as part of a second process for Matching and Suggestion of Publication Content.

According to some embodiments, a Digital Content Characterization Processor of an exemplary CCMBoxes system may execute a Matching and Suggestion of Content to/for CCMBox(es) and Publishers process. An exemplary Matching and Suggestion of Content to/for CCMBox(es) and Publishers process may include some or all of the following operation steps and flow:
(1) Monitor the generation, acquisition and/or uploading/contribution(i.e. CCMBox inclusion) of Content items (e.g. the user taking a photo and saving it on his device storage). Upon a new content item(s) generated, acquired, or uploaded by user, in parallel:
(2) Retrieve ratings and tags (e.g. as described in FIGS. 8A and 8B) of existing CCMBoxes and users (supplier, publisher, viewer)

### And:

(2′) Calculate a rating(s) and assign tag(s) (e.g. as described in FIGS. 8A and 8B) to newly generated/acquired/uploaded content item(s).

### Then:

(3) Compare tags of existing entities (Content Items, CCMBoxes, Users) to tags of newly generated/acquired/uploaded content items.
(4) Based on existing entities' tags to new content items' tags matchings, and optionally excluding entities filtered out as having a low/unwanted ratings, generate suggestions of: (i) Existing CCMBoxes that match the new content item(s)—to generator/acquirer/uploader of new content items and/or (ii) Context/ideas for new articles/posts/publications based on the newly generated/acquired/uploaded content item(s)—to matching publishers.
(5) and Relay the suggested CCMBoxes and/or context/ideas to the relevant generator/acquirer/uploader and/or publisher(s).

In FIG. 8E there is shown a flowchart diagram describing the main processes and operation steps, executed by a Digital Content Characterization Processor, as part of a process for Matching and Suggestion of Content to/for CCMBox(es) and Publishers.

According to some embodiments, a Digital Content Characterization Processor of an exemplary CCMBoxes system may execute a Suggestion of Requested/Aspired Content for CCMBox(es) to Content Suppliers/Contributors process. An exemplary Suggestion of Requested/Aspired Content for CCMBox(es) to Content Suppliers/Contributors process may include some or all of the following operation steps and flow:
(1) Monitor the generation/addition/publication of new, or being updated, CCMBoxes/Publications.
   Upon a New CCMBox(es)/Publication, in parallel:
(2) Calculate a rating and assign tag(s) (e.g. as described in FIGS. 8A and 8B) to newly generated/added/published CCMBox(es).

### And:

(2′) Retrieve and Generate aspired-content-items indicative data of/about newly generated/added/published CCMBox(es). CCMBox (es) aspired-content-items indicative data may include or be based on: (i) Textual Photo-wishes, (ii) Locations based on CCMBox dedicated location, (iii) Location based on text analysis from article/photo-wish and/or (iv) Significant places/people/events based on text analysis for keywords.

### Then:

(3) Compare tags of existing content item suppliers/contributors to tags of newly generated/added/published CCMBox.
(4) Based on existing content item suppliers/contributors tags to new CCMBox(es) tags matchings, and optionally excluding entities filtered out as having a low/unwanted ratings, select suppliers/contributors matching the new CCMBox(es).
(5) and Selectively relay the aspired-content-items indicative data of/about new CCMBox(es) to matching content item suppliers/contributors, for example, in the form of an assignment/task/mission notification to go and acquire/produce/contribute/supply content items matching their location, experience and/or fields of interest.

In FIG. 8F there is shown a flowchart diagram describing the main processes and operation steps, executed by a Digital Content Characterization Processor, as part of a process for Suggestion of Requested/Aspired Content for CCMBox(es) to Content Suppliers/Contributors.

According to some embodiments, a Digital Content Characterization Processor of an exemplary CCMBoxes system may execute a Supplier/Contributor Content Item Portfolio Management process. An exemplary Supplier/Contributor Content Item Portfolio Management process may include some or all of the following operation steps and flow:

### In Parallel:

(1) Retrieve content items in a portfolio (i.e. content items previously contributed to CCMBoxes by the specific supplier) of a content supplier/contributor, including: (i) Ratings of content items in the portfolio, (ii) Data (e.g. content items pricing) from other existing online portfolios of the content supplier (e.g. obtained by acquiring databases and\or web-crawling and scanning portfolios) and/or (iii) Reviews of content items in the portfolio by peers/professionals.

### In Parallel:

(2) Generate a customized portfolio layout/structure suggestion, based on the retrieved and collected data (e.g. present content items from most appealing to least) and/or construct an online/offline portfolio for the respective content supplier/contributor.

### And:

(2′) Calculate and suggest a price or price range for content items (e.g. photos, paintings) in the portfolio of the content supplier/contributor, based on analysis of rating.
   Then, Based on outputs of step 2 and step 2′:
(3) Generate a professional portfolio for the media contributor, based on a given platform or the ability to export and establish on 3rd party platforms, via embedded code and\or our API. Portfolio will consist media contributor's uploaded media to all\some CCMBoxes, and\or optimized customized layout and\or pricing based on previously calculated.
(4) Relay suggested prices and portfolio layout/structure suggestions to respective portfolio's content suppliers/contributors.

### And/or Optionally:

(5) Create an auction content for items in the portfolio, which will be part of the contributor's online portfolio. Customers\viewers\participants in the auction could be open for public\given\invited consumers, and transactions will be allowed for consumers to purchase media contributor's media in portfolio.

In FIG. 8G there is shown a flowchart diagram describing the main processes and operation steps, executed by a Digital Content Characterization Processor, as part of a process for Supplier/Contributor Content Item Portfolio Management.

According to some embodiments, a CCMBox may comprise one or more electronic interfaces for automatically managing and facilitating user management of the CCMBox and the media content contained therein. Electric management interfaces may include, but are not limited to: a standalone mobile application, a web-browser based application, and/or a built-in plugin or add-on for publishing/website-construction platform(s) (e.g. WordPress, Wix). The electronic interfaces may receive CCMBox management instructions: communicated by users such as CCMBox publishers or curators, and/or generated/triggered by an automatic CCMBox management logic of the CCMBox.

According to some embodiments, media item types in a managed CCMBox may include any type(s) of digital media, including, but not limited to: photo/image media/file types, video media/file types, audio media/file types, text media/file types; ad(s) of any form or media/file type, map/drawing/blueprint./sketch media/file types, other document media/file types, code snippets or library procedure/function media/file types, VR media/file types, and/or any other digital media/file/data-structure type known today or to be devised in the future.

According to some embodiments, the CCMBox managerial actions may be triggered and/or executed by an administrating user such as a CCMBox publisher or curator, wherein at least some of the actions may be fully or partially triggered and/or executed automatically. Automatic triggering and/or execution of management actions may: utilize a respective algorithm(s) or processing logic(s) (may be referred to as ‘fully automatic’), and/or may combine between an algorithm(s)/processing-logic(s) and/or crowdsourced manual managerial action triggering and execution (may be referred to as ‘semi-automatic’).

CCMBox(es) managerial actions may include any combination of the following:
(1) Approving for CCMBox publication a new media item. May also be triggered/executed automatically by continuously monitoring rating values of publication pending items, and automatically publishing them upon reaching a rating threshold value. Or, may also be triggered/executed automatically by pre-determined “automatic filters” as defined by the owner\publisher\editor, such as auto-approve media items from certain content contributors (by choice, rating, other characteristic) or combination of such definitions, for example, photos in winter category, with rating of at least 9, from photographers of rating 8 and from Sweden.
(2) Rejecting for CCMBox publication a new media item. May also be triggered/executed automatically by continuously/intermittently monitoring rating values of publication pending items, and automatically rejecting them upon reaching a rating threshold low value; and/or scanning items using an image analysis logic/technique, and automatically rejecting items including, for example: violent, sexually offensive, inciting and/or racist—content elements (e.g. language, images).
(3) Removing from a live CCMBox a published media item. May also be triggered/executed automatically by continuously/intermittently monitoring rating values of CCMBox published media items, as they continue to receive user (e.g. consumer/viewer) ratings, and automatically rejecting those reaching a rating threshold low value or those found/reported to include abusive content.
(4) Receiving and adding a comment or feedback to a published item.
(5) Making changes\alterations to a CCMBox published media item (under defined constraints\permissions from media contributor). May also be triggered/executed automatically by continuously/intermittently monitoring rating values of CCMBox published media items, and automatically ‘opening’ (i.e. allowing access to and changing of) those reaching a rating threshold low value (e.g. a low value that is higher than the automatically rejecting value).
(6) Restoring a removed\rejected media item back to CCMBox, wherein restoring may be at least partially limited to items removed\rejected by a publisher or a curator, but not to items removed/rejected by media contributors/suppliers. May also be triggered/executed automatically by continuously/intermittently monitoring the number of items in a given CCMBox and restoring previously removed/rejected items as the number of items in the given CCMBox goes below a threshold low value for the minimal number of items within the CCMBox at any given time.
(7) Changing the presentation order of items within a given CCMBox. May also be triggered/executed automatically by continuously/intermittently monitoring rating values of CCMBox published media items, as they continue to receive user (e.g. consumer/viewer) ratings, and automatically prioritizing items that reached higher ratings than their counterparts, by presenting them prior to items now having a lower rating.
(8) Changing the functionality of a media item in a CCMBox (e.g. playing only a sub section of a video file). May also be triggered/executed automatically by continuously/intermittently monitoring user reactions to the item and accordingly changing it. For example, a video media item having specific section(s) that is/are more popular with viewers (e.g. watched by many but watched to end by few), may be automatically truncated and re-edited to only include popular sections/segments.
(9) Changing featured media (e.g. featured post\article photo showing up in web searches). May also be triggered/executed automatically by intermittently/periodically/randomly changing the featured media of the CCMBox, or by continuously/intermittently monitoring ratings of the CCMBox media items and automatically electing and presenting as feature item(s), items having the highest rating.
(10) Changing CCMBox properties (e.g. name, title, brief). May also be triggered/executed automatically by monitoring the popularity of properties as suggested by viewers of CCMBox items and electing the most popular ones, by swopping between multiple properties (e.g. multiple CCMBox names) based on a predetermined publisher/curator scheme, and/or based on external information retrieved by a communication component or an Internet bot of the CCMBox (e.g. the name, or part thereof, is automatically elected based on the current season or outside temperature as retrieved from a weather forecast website). According to some embodiments, moving/copying the CCMBox to another context/location may result in auto change of its title, brief, name and/or other characteristic.
(11) Controlling of CCMBox availability for media item contribution (i.e. pause CCMBox from accepting new media items). May also be triggered/executed automatically by registering a predefined/requested number of items (e.g. number supplied by publisher at CCMBox origination) and continuously/intermittently monitoring the number of items supplied and approved for publication within the CCMBox, wherein upon reaching the predefined/requested number of items the CCMBox is automatically ‘locked’ for further media item receipt/approval.
(12) Defining and enforcing requirements for contributed media (e.g. minimum size of photo, maximum length of video), wherein requirements may be manually entered (e.g. requirement supplied by publisher at CCMBox origination) or may be based on one or more automatically monitored/discovered constrains inherent to the type of publication (e.g. blog, website, specific platform mobile application) containing the CCMBox. May also be triggered/executed automatically by scanning/examining all media items pending publication approval and only approving requirements withstanding items.
(13) Facilitating and controlling the sharing of specific CCMBox(es) and/or specific content items included in CCMBox(es) between different users (publishers. contributors, consumers).
(14) Facilitating and controlling the export or relay of specific CCMBox(es) and/or specific content items included in CCMBox(es) to other file formats or storage-destinations (e.g. export/convert content item to video/gif. animation).
(15) Controlling of sharing availability of the CCMBox. May also be triggered/executed automatically by keeping a record of the number of times the CCMBox is shared (i.e. added/integrated into additional publications beyond the original one) and preventing its further sharing upon a predefined number of sharings being reached, by monitoring the time and preventing its sharing during specific predefined times of day and/or when auto-scheduling publishing of a publication/post/article—scheduling may enable sharing only when publication/post/article is live.
(16) Controlling of sharing availability of media items inside the CCMBox. May also be triggered/executed automatically by keeping a record of the number of times each of a set of media items within a CCMBox are shared (i.e. added/integrated into additional CCMBoxes beyond the original one) and preventing the further sharing of specific media items in the CCMBox upon a predefined number of sharings being reached, or by monitoring the time and preventing item sharing during specific predefined times of day.
(17) Monitoring requests (e.g. server/data-storage requests) for presentation of content items, generating content item exposure statistics based on the monitored presentation requests—wherein exposure statistics may be on a per content supplier/contributor/owner (or supplier/contributor/owner groups) base, and communicating content items exposure statistics to their respective suppliers/contributors/owners.
(18) Restricting the exposure of specific content items based on requests from their suppliers/contributors and/or deleting them altogether based on a corresponding request.
(19) Controlling of allowed\blocked media item suppliers/contributors source/type (for example: accept media only from a certain country). May also be triggered/executed automatically by only accepting, for further publication approval examination, media items from devices having an IP address associated with specific countries/locations—as defined during CCMBox origination or at a later stage.
(20) Controlling of media items' exclusiveness (e.g. exclusive use of a photo in only one specific CCMBox). Controlling of an entire CCMBox's exclusiveness may include preventing it from being copied\reused in the platform by other publishers, websites and/or optionally, even by its own publisher; automatic application of exclusiveness limitations may be automatically triggered when a certain CCMBox reaches a certain popularity, for example, since the CCMBox gains “value” faster and becomes valuable\expensive its exclusiveness limitations may be now enforced, or more strictly enforced (to a higher level).
(21) Facilitating monetary transactions between any of the system users in the context of CCMBox(es) and/or content items within them, for example, between content suppliers/contributors that contributed content to the CCMBox(es). Transactions may be executed with digital currency (real currency or internal currency) among the contributors and/or possibly with the publisher(s) of the corresponding CCMBox(es), forming a kind of community(ies) around a context(s) of the CCMBox(es) and/or content item(s) they include.

According to some embodiments, some or all of the above described management actions include automatic actions related to the ratings of media item, but may be likewise, or in combination, applied/decided using content items suppliers'/contributors' ratings.

According to some embodiments, some or all of the above described management actions may be solely offered as premium service features, for users who bought, or were elsewise upgraded to, a premium version of the management application/service/tool.

According to some embodiments, a CCMBox may comprise one or more image, video, or audio processors for processing digital content within the CCMBox prior to presentation of the digital content. CCMBox image, video, or audio processing may include any of the following:

According to some embodiments, digital content may be processed to improve its quality. Digital content quality related processing may include: application of filters, tuning of contrast, tuning of colors and shades, tuning of brightness of images or video digital content items and/or processing/modifying/tuning any other digital image properties.

According to some embodiments, digital content quality related processing may include audio quality processing such as: application of acoustic filters, amplification or amplification of specific frequencies and/or noise removal.

According to some embodiments, digital content may be processed to change/modify its content and/or size. Digital content related processing of the content may include: identification and marking of elements (e.g. faces) within images or videos, deletion or blurring of elements within images or videos, marking or highlighting of elements within images or videos and/or the addition or augmentation of elements (e.g. animated images/icons, information layers) onto images or videos.

According to some embodiments, digital content may be processed to include a graphic code (e.g. QR code), an icon and/or a watermark. The graphic-code/icon/watermark may be automatically embedded into digital content items in the CCMBox, for example, at their CCMBox presentation approval or prior to their presentation.

According to some embodiments, added icons/watermarks may provide copyright protection and security for content suppliers/contributors to keep their contributed digital content from being stolen\copied. According to some embodiments, added icons/watermarks may provide labeling\branding—marking the digital content items as part of the platform's label\brand or as white/elsewise labeled to another brand.

According to some embodiments, added icons may include embedded links that may be engaged by consumers/viewers of the digital content items of the CCMBox. Embedded links may lead engaging consumers/viewers to web places/locations associated with the content items they are embedded in (e.g. content supplier work portfolio, information about the location where the content item was acquired).

According to some embodiments, the embedded links may lead the consumer/viewer to locally or remotely stored insights related to the specific CCMBox or CCMBox content items the consumer/viewer is engaging with. Insights may, for example include: Worldviews, audience insights, categorization related insights, and/or Alexa/other traffic/popularity related insights.

According to some embodiments, added graphic-codes may include embedded links that may be engaged, using graphic-code scanning applications, by consumers/viewers of the digital content items of the CCMBox. Scanned graphic-codes may lead engaging consumers/viewers to web places/locations associated with the content items they are embedded in (e.g. content supplier work portfolio, information about the location where the content item was acquired).

According to some embodiments, digital content items and/or CCMBoxes may be processed to include appended text captions and/or badges indicating achievements (e.g. popularity, exposure) of specific CCMBoxes or content items.

According to some embodiments, a CCMBox may comprise an electronic interface for presenting a selection of digital content items from the collection within the CCMBox based on one or more presentation rules and/or schemes.

According to some embodiments, a CCMBox may present to a consumer/viewer, or relay for presentation on a consumer/viewer communication device, the selection of digital content items. The electronic interface for presenting a selection of digital content items may present the content items as a customized presentation.

According to some embodiments, the CCMBox may receive through the electronic (presentation) interface control commands from the Curator of the CCMBox and\or from the Publisher of the publication including the CCMBox.

Control commands may: instruct which digital content items to present and in which order; provide presentation customization parameters, such as display colors, dimensions and layout for visual digital content items presented, provide presentation theme/type selection (e.g. present a single content item at a time, present a collage/album of x content items, present as a slideshow or gallery, present a subset of specific content items)

According to some embodiments, the electronic (presentation) interface may present multiple CCMBoxes and/or multiple selected content CCMBoxes to a consumer/viewer. The CCMBoxes and/or content items may be presented in different layouts, optionally within the same presentation space (e.g. page, window).

According to some embodiments, consumers/viewers preferences of CCMBoxes and CCMBoxes digital content items may be registered by the electronic (presentation) interface. Per consumer/viewer presentation adaptations (e.g. font size, skin/theme) may be implemented as an external service/plugin, possibly overriding the default preferences.

According to some embodiments, the CCMBoxes may provide/present/relay digital content items as a service (e.g. via AP1\plugin\other method). 3rd parties may use the service, with an API for example, to retrieve digital content items of a specific CCMBox and present/display it as they wish. The presentation/display within 3rd party environment (e.g. 3rd party website) may override at least some of the preferences defined by the consumer/viewer and/or by the publisher/administrator.

According to some embodiments, consumers/viewers may be associated with: certain content presentation/display medium(s) (e.g. page, location, article), one or more CCMBoxes and a respective consumer/viewer set of preferences. Accordingly, the same CCMBox(es) and/or digital content items, may be presented to the same consumer/viewer, under different presentation properties/settings. For example, a specific CCMBox (and its included content items) presented' at a first webpage to a given consumer/viewer with skin 1, may be presented to the same given consumer/viewer with skin 2 on a second webpage. According to some embodiments, defined global and/or specific presentation/display preferences may be received from the publisher/administrator of the CCMBox and implemented as part of its presentation.

According to some embodiments, the electronic (presentation) interface of a CCMBox may apply multiple rules/schemes for the presentation of a selection of digital content items from within the CCMBox. Presentation rules/schemes may include:
(1) Select a mode of presentation based on the number of content items selected for presentation (e.g. below x photos present in a slideshow, above x photos display in a slider/thumbnails/gallery/list);
(2) Present a predefined number of selected digital content items before presenting external/additional (not part of digital content items in CCMBox) content items. For example, after presenting x photos display ads/related-posts/related photos/video; and/or
(3) Present selected digital content items: by random order, based content item associated text and its analysis outputs (e.g. groups, clusters, alphabetical order of acquisition location), by contributor ratings, by crowd ratings, by manually selected order and/or by any combination of the above.

According to some embodiments, the electronic (presentation) interface of the CCMBox may monitor and log/register the activity of the consumer/viewer in the digital environment (e.g. webpage) and\or digital properties about a consumer/viewer such as browser data, where the selected digital content items of the CCMBox are consumed. The activity of the consumer/viewer (e.g. browsed websites) may be analyzed and utilized for collection of—additional/new digital content to the CCMBox.

According to some embodiments, the electronic (presentation) interface of a CCMBox may control the presentation features of the CCMBox and its selected digital content items. The electronic (presentation) interface of the CCMBox may present the CCMBox, its selected content items and/or its featured content items (described hereinbefore), in different presentation versions (i.e. schemes/combinations/themes/orders/layouts combinations) to different consumers/viewers or consumer groups. Consumers/viewers feedbacks to different presentation versions may be automatically compared and the presentation versions triggering good/better feedback results may be applied to a larger number of, or to future, consumers/viewers. According to some embodiments, traffic in a specific pages/posts/websites/CCMBoxes may be accordingly optimized.

According to some embodiments, the electronic (presentation) interface of a CCMBox may present different digital content items to different consumers/viewers while measuring which content item combination had the best higher/better results. The quality of the results may be measured by any of the following methods, optionally selected by the CCMBox/CCMBox-publication publisher: (1) the number of consumers/viewers on a site/page/CCMBox, wherein the number of consumers/viewers may be the total, unique, new, or returning consumers/viewers on the site/page/CCMBox; (2) the level of interaction with the digital content media items of the CCMBox(es), for example, enlarging a content item photo or playing a content item video; and/or (3) specific preferences of consumers/viewers types—geolocations, browser used, browser language and all data that is available on consumers/viewers consuming the presented content items, for example targeting as many consumers/viewers from North America who are also English speakers.

According to some embodiments, the electronic (presentation) interface of a CCMBox may modify/alter/switch-between any of the following, changeable, presentation elements, as part of testing multiple presentation versions on different consumers/viewers: (1) the order of content items; (2) the layout or arrangement scheme of the content items; (3) the media type of the presented content items (e.g. only video items vs. only still image items); (4) the featured content items of the CCMBox/publication shown in parent pages, social media and/or search results; and/or (5) the content items selected for presentation in the CCMBox.

According to some embodiments, a system for generating and managing virtual digital content item collections, may comprise: a first electronic interface configured to interface with a publisher user and receive from the publisher user a set of parameters defining rules of inclusion and context parameters of a new digital item collection; a first data storage containing a list of approved digital content suppliers; a second electronic interface configured to interface with one or more digital content suppliers of the approved digital content suppliers, communicate to the one or more digital content suppliers the rules of inclusion and context parameters of the new digital item collection and receive from the one or more digital content suppliers candidate digital content items for the new digital item collection; a second data storage adapted to store collections of digital content items and sets of data relating to individual items of the stored digital content items in correlation to the stored digital content items; a Digital Content Item Collection Management Box (CCMBox) computerized server coupled to the first interface, the second interface and the data storage and configured to: select digital content items to be added to the new digital item collection from the candidate digital content items and store the selected digital content items in the second data storage as members of the new digital item collection.

The system CCMBox computerized server may be configured to automatically select digital content items to be added to the new digital item collection from the candidate digital content items by applying the rules of inclusion to the candidate digital content items.

The may further comprise a third electronic interface configured to interface with a curator user, present to the curator user the candidate digital content items and receive from the curator user selections of digital content items to be added to the new digital item collection from the candidate digital content items.

The system's context parameters may include a text associated with the CCMBox.

The system may further comprise processing circuitry configured to characterize the selected digital content items based on the text.

The system's context parameters may include a web page where the new digital item collection is to be displayed.

The system's context parameters may include an article where the new digital item collection is to be displayed.

The system's rules of inclusion may include criteria defining characteristics of digital content suppliers allowed to supply candidate digital content items to the new digital content collection.

The system may further comprise a computerized server configured to record data relating to viewing of viewed digital content items within digital content item collections and derive ratings of the viewed content items and digital content suppliers that supplied the viewed content items from the recorded data.

The system's CCMBox computerized server may be further configured to facilitate communication between digital content suppliers and the publisher user or the curator user.

The system may further comprise digital memory containing computer executable code designed to cause a second processor to instance a publisher application upon a device containing the second processor, the publisher application being configured to interface with the first interface and facilitate interaction between the publisher user and the system.

The system may further comprise digital memory containing computer executable code designed to cause a second processor to instance a content supplier application upon a device containing the second processor, the content supplier application being configured to interface with the second interface and facilitate interaction between the one or more digital content suppliers and the system.

According to some embodiments, a method for generating and managing virtual digital content item collections may comprise: using a first electronic interface to interface with a publisher user and receive from the publisher user a set of parameters defining rules of inclusion and context parameters of a new digital item collection; maintaining a list of approved digital content suppliers in a first data storage; using a second electronic interface to interface with one or more digital content suppliers of the approved digital content suppliers, communicate to the one or more digital content suppliers the rules of inclusion and context parameters of the new digital item collection and receive from the one or more digital content suppliers candidate digital content items for the new digital item collection; storing and maintaining collections of digital content items and sets of data relating to individual items of the stored digital content items in correlation to the stored digital content items within a second data storage; using a Digital Content Item Collection Management Box (CCMBox) computerized server coupled to the first interface, the second interface and the data storage to: select digital content items to be added to the new digital item collection from the candidate digital content items and store the selected digital content items in the second data storage as members of the new digital item collection.

The method may further include configuring the CCMBox computerized server to automatically select digital content items to be added to the new digital item collection from the candidate digital content items by applying the rules of inclusion to the candidate digital content items.

The method may further include configuring a third electronic interface to interface with a curator user, present to the curator user the candidate digital content items and receive from the curator user selections of digital content items to be added to the new digital item collection from the candidate digital content items.

The method may use context parameters including a text associated with the CCMBox.

The method may further include configuring a processing circuitry to characterize the selected digital content items based on the text.

A virtual digital content item collection box (CCMBox) may comprise: a first data storage containing a list of approved digital content suppliers; a digital medium containing a set of parameters defining rules of inclusion and context parameters of the CCMBox; a first electronic interface configured to interface with one or more digital content suppliers, communicate to the digital content suppliers the rules of inclusion and context parameters and receive from the digital content suppliers candidate digital content items for the new digital item collection; a second data storage adapted to store collections of digital content items and sets of data relating to individual items of the stored digital content items in correlation to the stored digital content items; a CCMBox computerized control coupled to the first interface and the data storage and configured to: select digital content items to be added to the new digital item collection from the candidate digital content items and store the selected digital content items in the second digital storage as members of the new digital item collection.

The subject matter described above is provided by way of illustration only and should not be constructed as limiting. While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A system for generating and managing virtual digital content item collections, said system comprising:
a first electronic interface configured to interface with a publisher user and receive from the publisher user a set of parameters defining rules of inclusion and context parameters of a new digital item collection;
a first data storage containing a list of approved digital content suppliers;
a second electronic interface configured to interface with one or more digital content suppliers of the approved digital content suppliers, communicate to the one or more digital content suppliers the rules of inclusion and context parameters of the new digital item collection and receive from the one or more digital content suppliers candidate digital content items for the new digital item collection;
a second data storage adapted to store collections of digital content items and sets of data relating to individual items of the stored digital content items in correlation to the stored digital content items;
a Digital Content Item Collection Management Box (CCMBox) computerized server coupled to said first interface, said second interface and said data storage and configured to:
(i) select digital content items to be added to the new digital item collection from the candidate digital content items; and
(ii) store the selected digital content items in said second data storage as members of the new digital item collection.

2. The system according to claim 1, wherein said CCMBox computerized server is configured to automatically select digital content items to be added to the new digital item collection from the candidate digital content items by applying the rules of inclusion to the candidate digital content items.

3. The system according to claim 1, further comprising a third electronic interface configured to interface with a curator user, present to the curator user the candidate digital content items and receive from the curator user selections of digital content items to be added to the new digital item collection from the candidate digital content items.

4. The system according to claim 1, wherein said context parameters include a text associated with the CCMBox.

5. The system according to claim 4, further comprising processing circuitry configured to characterize the selected digital content items based on the text.

6. The system according to claim 1, wherein the context parameters include a web page where the new digital item collection is to be displayed.

7. The system according to claim 1, wherein the context parameters include an article where the new digital item collection is to be displayed.

8. The system according to claim 1, wherein said rules of inclusion include criteria defining characteristics of digital content suppliers allowed to supply candidate digital content items to the new digital content collection.

9. The system according to claim 1, further comprising a computerized server configured to record data relating to viewing of viewed digital content items within digital content item collections and derive ratings of the viewed content items and digital content suppliers that supplied the viewed content items from the recorded data.

10. The system according to claim 1, wherein said CCMBox computerized server is further configured to facilitate communication between digital content suppliers and the publisher user or the curator user.

11. The system according to claim 1, further comprising digital memory containing computer executable code designed to cause a second processor to instance a publisher application upon a device containing the second processor, the publisher application being configured to interface with said first interface and facilitate interaction between the publisher user and said system.

12. The system according to claim 1, further comprising digital memory containing computer executable code designed to cause a second processor to instance a content supplier application upon a device containing the second processor, the content supplier application being configured to interface with said second interface and facilitate interaction between the one or more digital content suppliers and said system.

13. A method for generating and managing virtual digital content item collections, said method comprising:
using a first electronic interface to interface with a publisher user and receive from the publisher user a set of parameters defining rules of inclusion and context parameters of a new digital item collection;
maintaining a list of approved digital content suppliers in a first data storage;
using a second electronic interface to interface with one or more digital content suppliers of the approved digital content suppliers, communicate to the one or more digital content suppliers the rules of inclusion and context parameters of the new digital item collection and receive from the one or more digital content suppliers candidate digital content items for the new digital item collection;
storing and maintaining collections of digital content items and sets of data relating to individual items of the stored digital content items in correlation to the stored digital content items within a second data storage;
using a Digital Content Item Collection Management Box (CCMBox) computerized server coupled to said first interface, said second interface and said data storage to:
(i) select digital content items to be added to the new digital item collection from the candidate digital content items; and
(ii) store the selected digital content items in said second data storage as members of the new digital item collection.

14. The method according to claim 13, further including configuring the CCMBox computerized server to automatically select digital content items to be added to the new digital item collection from the candidate digital content items by applying the rules of inclusion to the candidate digital content items.

15. The method according to claim 13, further including configuring a third electronic interface to interface with a curator user, present to the curator user the candidate digital content items and receive from the curator user selections of digital content items to be added to the new digital item collection from the candidate digital content items.

16. The method according to claim 13, wherein said context parameters include a text associated with the CCMBox.

17. The method according to claim 16, further comprising configuring a processing circuitry to characterize the selected digital content items based on the text.

18. A virtual digital content item collection box (CCMBox), said CCMBox comprising:
a first data storage containing a list of approved digital content suppliers;
a digital medium containing a set of parameters defining rules of inclusion and context parameters of said CCMBox;
a first electronic interface configured to interface with one or more digital content suppliers, communicate to the digital content suppliers the rules of inclusion and context parameters and receive from the digital content suppliers candidate digital content items for the new digital item collection;
a second data storage adapted to store collections of digital content items and sets of data relating to individual items of the stored digital content items in correlation to the stored digital content items;
a CCMBox computerized control coupled to said first interface and said data storage and configured to:
(i) select digital content items to be added to the new digital item collection from the candidate digital content items; and
(ii) store the selected digital content items in said second digital storage as members of the new digital item collection.
